(19) United States
(12) Patent Application Publication
(10) Pub. No.: US 2025/0096501 A1
(43) Pub. Date: Mar. 20, 2025

(54) ELECTRIC CONNECTOR MOUNTED BODY, FIRST CONNECTOR, SECOND CONNECTOR, MODULE, AND MODULE COUPLED BODY

(71) Applicant: HIROSE ELECTRIC CO., LTD., Kanagawa (JP)

(72) Inventor: Yuya YOSHIHARA, Kanagawa (JP)

(21) Appl. No.: 18/824,463

(22) Filed: Sep. 4, 2024

(30) Foreign Application Priority Data
Sep. 14, 2023 (JP) 2023-149032

(51) Int. Cl. H01R 13/514; H01R 12/72

(52) U.S. Cl. CPC H01R 13/514; H01R 12/722

(57) ABSTRACT

An electric connector mounted body includes a circuit board and an electric connector pair, and can mate and connect to mating electric connector mounted bodies in a forward direction (mating direction) in a front-and-back direction perpendicular to a coupling direction. Electric connectors included in the electric connector pair each include a plurality of terminals, and a housing. The electric connectors include a first and a second connector. The first connector can mate and connect to a second mating connector of a mating electric connector mounted body. The second connector can mate and connect to a first mating connector of the other mating electric connector mounted body. The first connector has no portions that come into contact with the second mating connector from a front and from a back. The second connector has no portions that come into contact with the first mating connector from the front and from the back.

### CROSS-REFERENCE TO RELATED APPLICATION

This application claims priority from Japanese Patent Application No. 2023-149032 filed with the Japan Patent Office on Sep. 14, 2023, the entire content of which is hereby incorporated by reference.

### BACKGROUND

### 1. Technical Field

An aspect of the present disclosure relates to an electric connector mounted body, a first connector, a second connector, a module, and a module coupled body.

### 2. Related Art

A description of EP 1,173,902 B discloses a module coupled body. In the module coupled body, a plurality of modules (connector assemblies) to be arranged on one rail is coupled together. All the modules have the same configuration, and are configured in such a manner as to be capable of being attached to the rail from above. In the description of EP 1,173,902 B, adjacent modules are sequentially coupled. Therefore, the plurality of modules is coupled with a longitudinal direction of the rail as a coupling direction.

In each module, a circuit board is accommodated in a housing. A plurality of terminals including signal terminals and power terminals is mounted on the circuit board in an arranged state. Each of the signal terminals and the power terminals includes a male contact portion (blade contact) on one end side in the above coupling direction, and includes a female contact portion (spring arm) on the other end side. Each of the male contact portions has a shape of one plate with a terminal arrangement direction as a thickness direction. Each of the female contact portions is configured as a pair of plate-shaped arm portions that can deform elastically in the terminal arrangement direction. The male contact portions protrude from one of two side surfaces (surfaces perpendicular to the coupling direction) of the housing, the one being on the same side as the male contact portions (referred to here as the “male-side side surface” for convenience of description) (refer to FIG. 5 of the description of EP 1,173,902 B). The female contact portions are each accommodated in a groove portion extending in an up-and-down direction in a side surface on the same side as the female contact portions (referred to here as the “female-side side surface” for convenience of description) (refer to FIG. 6 of the description of EP 1,173,902 B).

When a module is attached at a position on the rail, the position being adjacent to another module that has already been attached to the rail, each of the male contact portions of one of the modules enters between a pair of arm portions of a respective male contact portion of the other module, and the male contact portion is compressed between the pair of arm portions. As a result, the terminals are brought into a connected state, and the modules are coupled together.

### SUMMARY OF INVENTION

An electric connector mounted body includes: a circuit board; and an electric connector pair mounted on a mount surface of the circuit board, in which the electric connector mounted body is configured to be capable of being coupled with a plurality of other electric connector mounted bodies, taking one predetermined direction as a coupling direction, the electric connector mounted body is configured to be capable of mating and connecting to a mating electric connector mounted body adjacent to each side of the electric connector mounted body in the coupling direction, taking, as a mating direction, a forward facing direction in a front-and-back direction perpendicular to the coupling direction, each of electric connectors included in the electric connector pair includes a plurality of terminals arranged taking, as a terminal arrangement direction, a direction perpendicular to both of the front-and-back direction and the coupling direction, and a housing that holds the plurality of terminals, the electric connector pair includes, as the electric connectors, a first connector mounted on one side of the circuit board in the coupling direction, and a second connector mounted on the other side of the circuit board in the coupling direction, the first connector is configured to be capable of mating and connecting to a second mating connector provided to the mating electric connector mounted body, the second connector is configured to be capable of mating and connecting to a first mating connector provided to the other mating electric connector mounted body, the first connector has no portions that come into contact with the second mating connector from a front and from a back, and the second connector has no portions that come into contact with the first mating connector from the front and from the back.

### BRIEF DESCRIPTION OF DRAWINGS

FIGS. 1A and 1B are perspective views of a module coupled body according to an embodiment of the present disclosure, FIG. 1A illustrates a state immediately before one module is mated and connected, and FIG. 1B illustrates a state where all modules are coupled together;

FIGS. 2A and 2B are perspective views of a single module, and FIG. 2C is a diagram of coupled portions of two adjacent modules as viewed in a front-and-back direction;

FIGS. 3A and 3B are perspective views illustrating electric connector mounted bodies alone provided to the module coupled body, FIG. 3A illustrates a state immediately before one electric connector mounted body is inserted and connected, and FIG. 3B illustrates a state where all the electric connector mounted bodies are connected together;

FIGS. 4A and 4B are perspective views of a control female connector mounted on a circuit board, FIG. 4A illustrates a state of the control female connector as viewed from the other end side of the circuit board, and FIG. 4B illustrates a state of the control female connector as viewed from one end side of the circuit board;

FIG. 5 is a perspective view illustrating members forming the control female connector, which are separated from one another;

FIG. 6A is a perspective view of a signal female terminal of the control female connector, FIG. 6B is a perspective view of a power female terminal of the control female connector, and FIG. 6C is a front view of the control female connector;

FIGS. 7A and 7B are cross-sectional views of the control female connector, taken along planes perpendicular to a terminal arrangement direction, FIG. 7A illustrates a cross section of the control female connector at a position of a fixed-side restriction portion, and FIG. 7B illustrates a cross section of the control female connector at a position of a moving-side restriction position;

FIGS. 8A and 8B are perspective views of a control male connector mounted on the circuit board, FIG. 8A illustrates a state of the control male connector as viewed from the one end side of the circuit board, and FIG. 8B illustrates a state of the control male connector as viewed from the other end side of the circuit board;

FIG. 9 is a perspective view illustrating members forming the control male connector, which are separated from one another;

FIG. 10A is a perspective view of a signal male terminal of the control male connector, FIG. 10B is a perspective view of a power male terminal of the control male connector, and FIG. 10C is a front view of the control male connector;

FIGS. 11A and 11B are cross-sectional views of the control male connector, taken along planes perpendicular to the terminal arrangement direction, FIG. 11A illustrates a cross section of the control male connector at a position of the signal male terminal, and FIG. 11B illustrates a cross section of the control male connector at a position of the power male terminal;

FIGS. 12A and 12B are perspective views of a power male connector mounted on the circuit board, and FIG. 12C is a perspective view of a power male terminal of the power male connector;

FIGS. 13A and 13B are perspective views of a power female connector mounted on the circuit board, and FIG. 13C is a perspective view of a power female terminal of the power female connector;

FIGS. 14A and 14B are cross-sectional views of the electric connector mounted bodies immediately before start of a mating and connection operation, taken along a plane perpendicular to the terminal arrangement direction, FIG. 14A illustrates a cross section of the electric connector mounted bodies at a position of signal terminals of a control connector pair, and FIG. 14B illustrates s cross section of the electric connector mounted bodies at a position of power terminals of the control connector pair;

FIGS. 15A and 15B are cross-sectional views of the electric connector mounted bodies in the middle of the mating and connection operation, taken along the plane perpendicular to the terminal arrangement direction, FIG. 15A illustrates a cross section of the electric connector mounted bodies at the position of the signal terminals of the control connector pair, and FIG. 15B illustrates a cross section of the electric connector mounted bodies at the position of the power terminals of the control connector pair;

FIGS. 16A and 16B are cross-sectional views of the electric connector mounted bodies in a mated and connected state, taken along the plane perpendicular to the terminal arrangement direction, FIG. 16A illustrates a cross section of the electric connector mounted bodies at the position of the signal terminals of the control connector pair, and FIG. 16B illustrates a cross section of the electric connector mounted bodies at the position of the power terminals of the control connector pair;

FIG. 17A is a perspective view illustrating a control male connector and the control female connector in the mated and connected state, and FIG. 17B is a diagram illustrating an enlarged latched part of the control male connector and the control female connector in the mated and connected state; and

FIG. 18A is a perspective view illustrating the power male connector and a power female connector in the mated and connected state, and FIG. 18B is a diagram illustrating an enlarged latched part of the power male connector and the power female connector in the mated and connected state.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

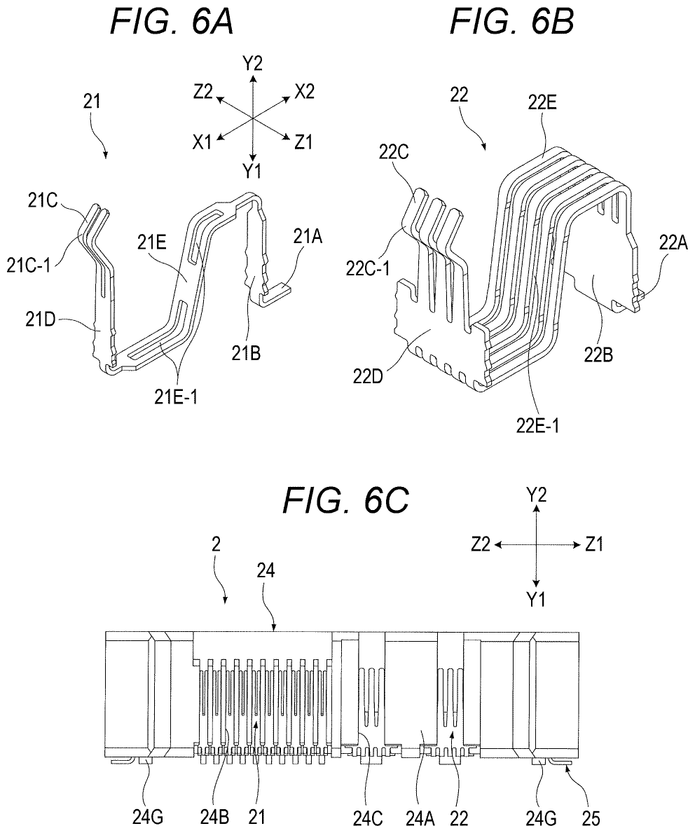

In the module coupled body described in the description of EP 1,173,902 B, the groove portions that each accommodate the female contact portion of a respective power terminal in the female-side side surface of the housing are covered with a plate-shaped cover portion at the middle position in the up-and-down direction (refer to FIG. 6 of the description of EP 1,173,902 B). The female contact portions of the power terminals are accommodated in the groove portions at a position directly below the cover portion. Therefore, when the plurality of modules is in the coupled state, a cover portion of one of any two adjacent modules is present above the male contact portions of the other modules connected to the female contact portions of the one of the modules. Therefore, when three or more modules are in the coupled state, even if only a module at the middle position, that is, a module other than a module at each end position (here referred to the “middle module” for convenience of description) is attempted to be removed upward, male contact portions of power terminals of the middle module interfere with cover portions of adjacent modules from below. Accordingly, it is difficult to remove only the middle module.

Therefore, if only one middle module needs to be replaced, all the modules located on the male contact portion side relative to the middle module need to be temporarily removed first prior to the removable of the middle module. Moreover, all the modules on the male contact portion side need to be connected again after the above replacement of the middle module. In this manner, in the module coupled body described in the description of EP 1,173,902 B, the replacement work of the middle module is very complicated, so that working efficiency decreases significantly.

One object of the present disclosure is to provide an electric connector mounted body, a first connector, a second connector, a module, and a module coupled body, which allow easily conducting replacement work of the electric connector mounted body.

(1) An electric connector mounted body according to one aspect of the present disclosure includes: a circuit board; and an electric connector pair mounted on a mount surface of the circuit board, and is configured to be capable of being coupled with a plurality of electric connector mounted bodies, taking one predetermined direction as a coupling direction.

The electric connector mounted body is configured to be capable of mating and connecting to a mating electric connector mounted body adjacent to each side of the electric connector mounted body in the coupling direction, taking, as a mating direction, a forward facing direction in a front-and-back direction perpendicular to the coupling direction, each of electric connectors included in the electric connector pair includes a plurality of terminals arranged taking, as a terminal arrangement direction, a direction perpendicular to both of the front-and-back direction and the coupling direction, and a housing that holds the plurality of terminals, the electric connector pair includes, as the electric connectors, a first connector mounted on one side of the circuit board in the coupling direction, and a second connector mounted on the other side of the circuit board in the coupling direction, the first connector is configured to be capable of mating and connecting to a second mating connector provided to the mating electric connector mounted body, the second connector is configured to be capable of mating and connecting to a first mating connector provided to the other mating electric connector mounted body, the first connector has no portions that come into contact with the second mating connector from a front and from a back, and the second connector has no portions that come into contact with the first mating connector from the front and from the back.

In the electric connector mounted body, the first connector has no portions that come into contact with the second mating connector from the front and from the back. Furthermore, the second connector has no portions that come into contact with the first mating connector from the front and from the back. Therefore, when the need arises to replace only an electric connector mounted body at the middle position in the coupling direction in a state where three or more electric connector mounted bodies are coupled together, it is possible to easily remove the electric connector mounted body at the middle position while suppressing interference between the first connector and the second connector of the electric connector mounted body with the second mating connector and the first mating connector of the mating electric connector mounted body on each side of the electric connector mounted body. Moreover, a new replaced electric connector mounted body can be subsequently inserted between the mating electric connector mounted bodies on both sides while interference of the first connector and the second connector of the new electric connector mounted body with the second mating connectors and the first mating connectors of the mating electric connector mounted bodies is suppressed. Therefore, there is no need to attach and detach the other electric connector mounted bodies upon the replacement work of the electric connector mounted body at the middle position. Hence, the replacement work of the electric connector mounted body is easy, and working efficiency improves.

(2) The electric connector mounted body according to (1), in which the first connector may include a first terminal as the terminal, and a first housing as the housing that holds the first terminal, the second connector may include a second terminal as the terminal, and a second housing as the housing that holds the second terminal, the first housing may include a first latch portion that is capable of being latched to a second mating housing of the second mating connector in the coupling direction, and the second housing may include a second latch portion that is capable of being latched to a first mating housing of the first mating connector in the coupling direction.

In the electric connector mounted body of (2), the first housing is configured in such a manner as to be capable of being latched with the first latch portion to the second mating housing in the coupling direction. Moreover, the second housing is configured in such a manner as to be capable of being latched with the second latch portion to the first mating housing in the coupling direction. Therefore, when the electric connector mounted body is in a state of being coupled with the mating electric connector mounted body on each side of the electric connector mounted body in the coupling direction, the position of the electric connector mounted body relative to each mating electric connector mounted body stays within a predetermined allowable area in the coupling direction. As a result, it is possible to excellently secure a state in which the electric connector mounted body and each mating electric connector mounted body are in stable electrical contact with each other.

(3) The electric connector mounted body according to (1) or (2), in which the first connector may include a first terminal as the terminal, and a first housing as the housing that holds the first terminal, the second connector may include a second terminal as the terminal, and a second housing as the housing that holds the second terminal, the first housing may include a first abutting portion that is capable of abutting against a second mating housing of the second mating connector in the terminal arrangement direction, and the second housing may include a second abutting portion that is capable of abutting against a first mating housing of the first mating connector in the terminal arrangement direction.

In the electric connector mounted body of (3), the first housing is configured in such a manner as to be capable of abutting against the second mating housing in the terminal arrangement direction by means of the first abutting portion. Moreover, the second housing is configured in such a manner as to be capable of abutting against the first mating housing in the terminal arrangement direction by means of the second abutting portion. Therefore, when the electric connector mounted body is in a state of being coupled with the mating electric connector mounted body on each side of the electric connector mounted body in the coupling direction, the position of the electric connector mounted body relative to each mating electric connector mounted body stays within a predetermined allowable area in the terminal arrangement direction. As a result, it is possible to excellently secure a state in which the electric connector mounted body and each mating electric connector mounted body are in stable electrical contact with each other.

(4) The electric connector mounted body according to any one of (1) to (3) may include a plurality of types of the electric connector pairs. Each of the terminals of at least one type of specific electric connector pair may have a shape obtained by bending a metal plate member in a thickness direction thereof, and includes a contact portion that comes into contact with a mating terminal provided to the mating electric connector mounted body. Each of the contact portions may be configured to be capable of coming into contact with the mating terminal, taking a plate surface intersecting the coupling direction as a contact surface.

The contact surface of the contact portion of each of terminals of the electric

connector mounted body of (4) is a plate surface intersecting the coupling direction. Hence, it is possible to reduce the dimension of the contact portion in the coupling direction while securing a sufficiently large area of the contact surface. Therefore, it is possible to reduce the depth, that is, the dimension in the coupling direction, of a recessed portion that accommodates the contact portion in the housing. Hence, it is possible to make the shape of the housing simple, so that it is possible to secure sufficient strength for the housing.

(5) In the electric connector mounted body according to (4), the plurality of terminals provided to one electric connector of the specific electric connector pair may include a power terminal and a signal terminal, the power terminal may include a power contact portion as the contact portion capable of coming into contact with the mating terminal corresponding to the power terminal, the signal terminal may include a signal contact portion as the contact portion capable of coming into contact with the mating terminal corresponding to the signal terminal, and the power contact portion may be formed in such a manner as to extend in the front-and-back direction, and a front end thereof is located forward of the signal contact portion, and a back end thereof is located backward of the signal contact portion.

Contact between power terminals may be required prior to contact between signal terminals in the middle of the operation of mating electric connectors, depending on the specifications of the electric connectors. In the electric connector mounted body of (5), in terms of the terminal of the above one electric connector, a front end of the power contact portion extending in the front-and-back direction is located forward of the signal contact portion, and a back end of the power contact portion is located backward of the signal contact portion. Therefore, if the contact portions of a plurality of the mating terminals provided to the mating electric connectors are formed at the same position in the front-and-back direction, it is possible for the power contact portions to come into contact with each other before the signal contact portions come into contact with each other in the middle of the operation of mating the electric connectors. In this manner, the electric connector mounted body of (5) can excellently meet the requirements of the above specifications.

(6) In the electric connector mounted body according to (4) or (5), the contact portion of each of the terminals of at least one electric connector of the specific electric connector pair may be formed at a position closer to one end side of the terminal in a longitudinal direction thereof in such a manner as to extend in the front-and-back direction, each of the terminals may include a free end portion extending up to a free end on the one end side continuously with a back end of the contact portion, and a portion, which is coupled with the back end of the contact portion, of the free end portion may bend with a component directed toward an opposite side to the contact surface in the coupling direction.

In this manner, in the electric connector mounted body of (6), the portion, which is coupled with the back end of the contact portion, of the free end portion of the above terminal bends with the component directed toward the opposite side to the contact surface in the coupling direction. Therefore, when the mating electric connector mates to the above one electric connector from the above free end portion side, the mating terminal of the mating electric connector is less likely to interfere with the free end portion in the middle of the mating operation, and therefore, can excellently come into contact with the above contact portion. As a result, it is possible to excellently avoid damage caused by buckling of a part of the above terminal due to interference of the mating terminal with the free end of the terminal after start of the mating operation.

(7) The electric connector mounted body according to anu one of (1) to (6), may further include a plurality of types of the electric connector pairs. In the electric connector mounted body, the housing of one electric connector of at least one type of specific electric connector pair may include a fixed housing and a moving housing, and the terminals of the electric connector may be provided in such a manner as to bridge the fixed housing and the moving housing. The fixed housing may be fixed to the circuit board via the terminals, each of the terminals may include an elastically deformable elastic portion between a fixed-side held portion held by the fixed housing and a moving-side held portion held by the moving housing, and the moving housing may be configured to be movable relative to the fixed housing due to elastic deformation of the elastic portions.

In this manner, in the above one electric connector of the electric connector mounted body of (7), the moving housing is configured as what is called a floating connector that is configured in such a manner as to be movable relative to the fixed housing. Therefore, even if relative positions of the electric connector of the at least one type of specific electric connector pair and the mating electric connector of the mating electric connector mounted body, which corresponds to the electric connector, are displaced from their proper positions, the above moving housing can move (float) in a direction that absorbs the displacement. Consequently, it is possible to bring all the terminals of the electric connector into contact with the terminals of the mating electric connector.

(8) In the electric connector mounted body of (7), the fixed housing may include a fixed-side restriction portion capable of being latched to the moving housing in the coupling direction. In this manner, the fixed housing is provided with the fixed-side restriction portion to restrict the movement of the moving housing in the coupling direction and stay within a predetermined area. Therefore, it is possible to avoid excessive deformation of the elastic portions of the terminals due to excessive movement of the moving housing in the coupling direction.

(9) In the electric connector mounted body of (7) or (8), the moving housing may include a moving-side restriction portion protruding toward the mount surface of the circuit board and being capable of coming into contact with the mount surface. In this manner, the moving housing is provided with the moving-side restriction portion, so that the moving-side restriction portion comes into contact with the mount surface of the circuit board, and is subjected to restriction of the position in a direction perpendicular to the mount surface. Hence, it is possible to stabilize the position of the moving housing, and by extension of the terminals.

(10) In the electric connector mounted body according to any one of (7) to (9), the terminals may include a power terminal and a signal terminal, the power terminal may be formed to be larger in the terminal arrangement direction than the signal terminal, and the elastic portion of the power terminal may be formed to be longer than the elastic portion of the signal terminal.

A dimension in the terminal arrangement direction, that is, a terminal width dimension of the power terminal is generally greater than that of the signal terminal in many cases to increase the cross-sectional area for the purpose of passing a large current. If the elastic portion is formed on each of the power terminal and the signal terminal, when the lengths of the elastic portions of both terminals are equal, the elastic portion of the power terminal having a larger terminal width dimension is more resistant to elastic deformation than the elastic portion of the signal terminal. In the electric connector mounted body of (10), the elastic portion of the power terminal is formed to be longer than the elastic portion of the signal terminal. Hence, the elastic portion of the power terminal is made easier to deform elastically even if the terminal width dimension increases. As a result, the elastic portion of the power terminal and the elastic portion of the signal terminal can be elastically deformed at substantially the same level of springiness. Therefore, it is possible to smoothly float the moving housing.

(11) A first connector according to one aspect of the present disclosure is provided to the electric connector mounted body of any of (1) to (10).

(12) A second connector according to one aspect of the present disclosure is provided to the electric connector mounted body of any of (1) to (10).

(13) A module according to one aspect of the present disclosure includes: the electric connector mounted body of any of (1) to (10); and a case configured to accommodate the electric connector mounted body.

(14) A module coupled body according to one aspect of the present disclosure includes a plurality of the modules of (13) coupled together.

In one aspect of the present disclosure, it is possible to provide an electric connector mounted body, a first connector, a second connector, a module, and a module coupled body, which allow easily conducting replacement work of the electric connector mounted body.

An embodiment of the present disclosure is described hereinafter with reference to the accompanying drawings.

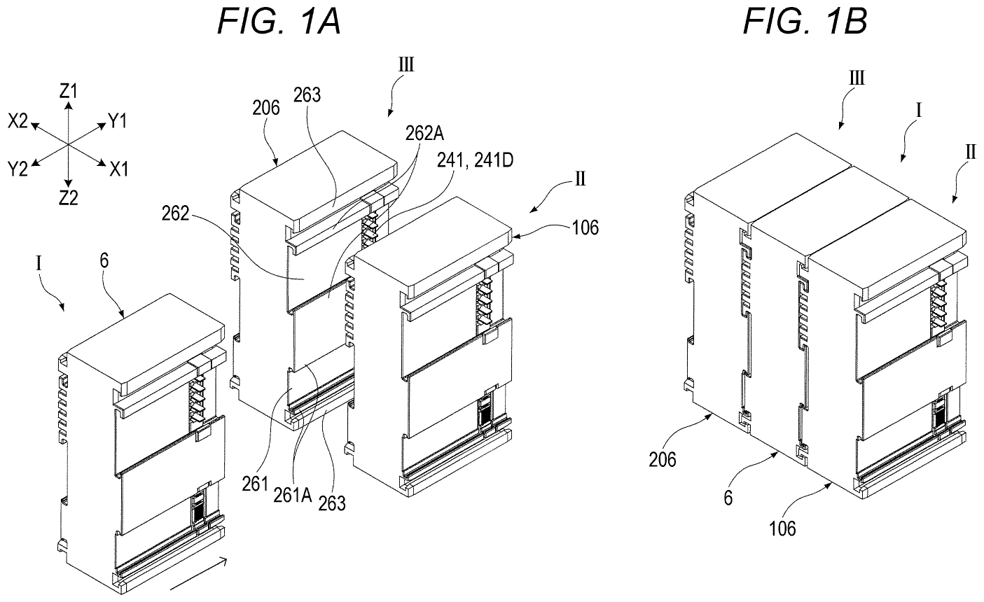

FIGS. 1A and 1B are perspective views of a module coupled body according to the embodiment of the present disclosure. FIG. 1A illustrates a state immediately before one module is mated and connected, and FIG. 1B illustrates a state where all modules are coupled together. The module coupled body of the embodiment is configured in such a manner that a plurality of modules is coupled together with one predetermined direction (an X-axis direction in FIGS. 1A and 1B) as a coupling direction. The module coupled body of the embodiment is used for, for example, a programmable logic controller (PLC) that, for example, controls a servomotor provided to a robot or the like via a servo amplifier.

The module coupled body of the embodiment includes three modules having the same configuration, or more specifically, a module I, a module II, and a module III. In the embodiment, the module II is placed on an X1 side of the module I in the coupling direction (the X-axis direction), and the module III on an X2 side. In other words, the module II, the module I, and the module III are placed sequentially from the X1 side in the coupling direction.

The modules I to III are attached to a rail (not illustrated) extending in the coupling direction in such a manner as to be attachable and detachable in a front-and-back direction (a Y-axis direction in FIGS. 1A and 1B) perpendicular to the coupling direction. Specifically, each of the modules I to III fits to the rail from the back (a Y2 side) via an attachment portion (not illustrated) provided to a front portion (a portion on a Y1 side) of the module I to III. Moreover, each of the modules I to III is configured in such a manner as to be mated and connected to adjacent modules at the same time as being attached to the rail.

FIG. 1A illustrates a state immediately before the module I is inserted between the module II and the module III, which have already been attached to the rail (not illustrated), put another way, a state immediately before the module I is mated and connected to the modules II and III. Moreover, FIG. 1B illustrates a state in which the module I, together with the modules II and III, is attached to the rail, put another way, a state in which the module I is mated and connected to the modules II and III and the modules I to III are coupled together.

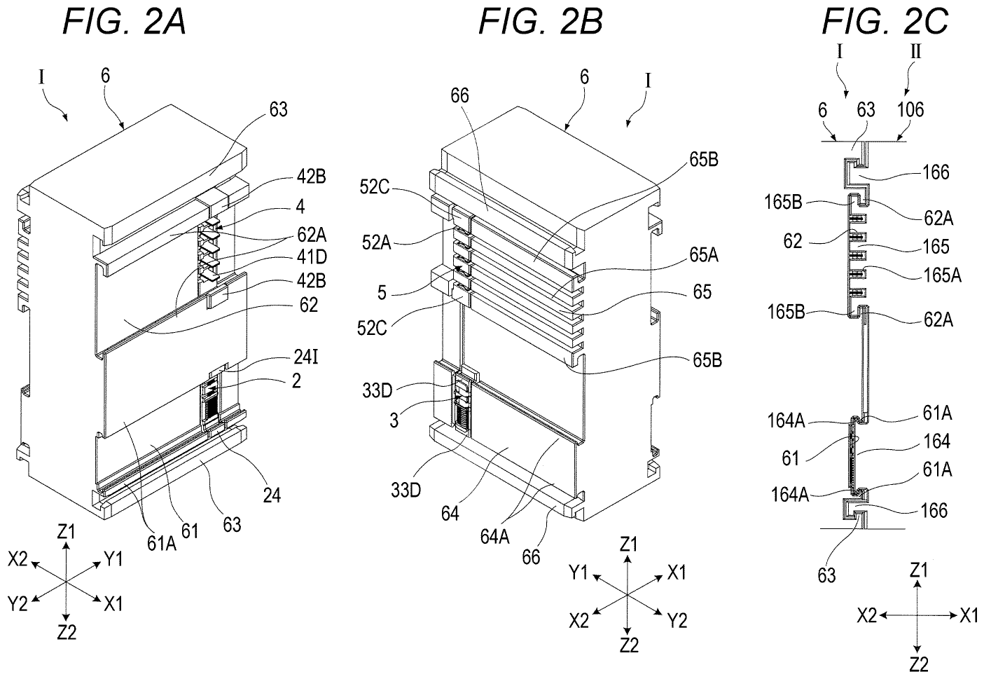

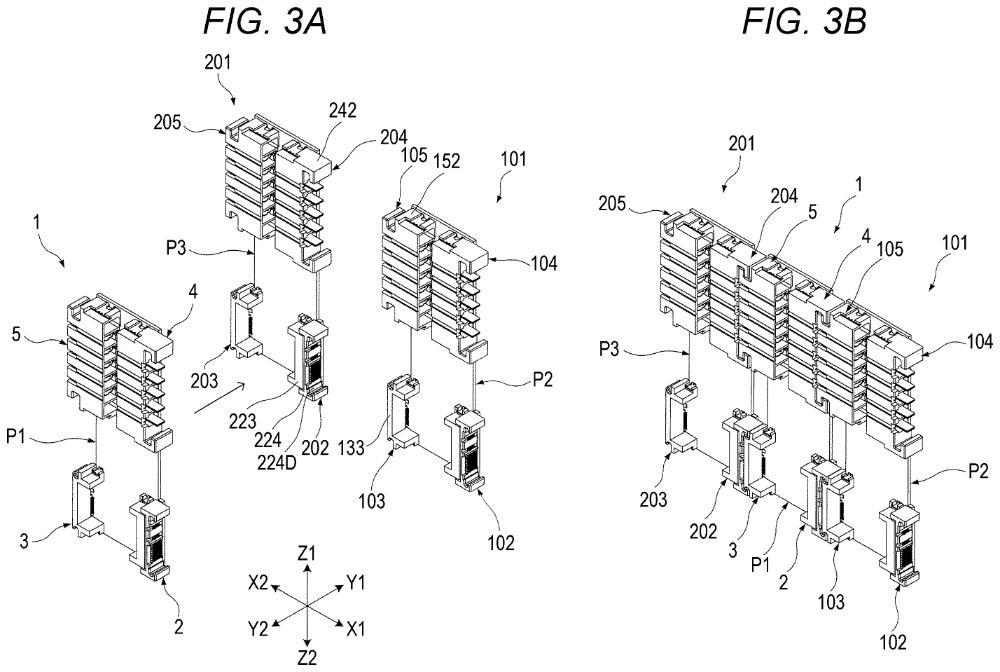

Next, the configurations of the modules I, II, and III, each as a single unit, are described. FIGS. 2A and 2B are perspective views of the module I as a single unit, and FIG. 2C is a diagram of coupled portions of two adjacent modules I and II as viewed in the front-and-back direction. As illustrated in FIGS. 2A and 2B, the module I includes an electric connector mounted body 1 (refer to FIGS. 3A and 3B), and a case 6 that accommodates the electric connector mounted body 1. The module II includes an electric connector mounted body 101 (refer to FIGS. 3A and 3B) as a mating electric connector mounted body, and a case 106 (refer to FIGS. 1A and 1B) that accommodates the electric connector mounted body 101. The module III includes an electric connector mounted body 201 (refer to FIGS. 3A and 3B) as a mating electric connector mounted body, and a case 206 (refer to FIGS. 1A and 1B) that accommodates the electric connector mounted body 201.

The electric connector mounted body 1, the electric connector mounted body 101, and the electric connector mounted body 201 may be simply called the “connector mounted body 1,” the “connector mounted body 101,” and the “connector mounted body 201,” respectively, below. In the embodiment, all the modules I to III are configured, having the same configuration. Hence, while the configuration of the module I is described, descriptions of the configurations of the modules II and III are omitted. Here, reference numerals obtained by adding “100” to reference numerals of the module I are assigned to portions, which correspond to the module I, of the module II. Reference numerals obtained by adding “200” to reference numerals of the module I are assigned to portions, which correspond to the module I, of the module III.

FIGS. 3A and 3B are perspective views illustrating the modules I, II, and III without the cases 6, 106, and 206. In other words, FIG. 3A is a perspective view illustrating the connector mounted bodies 1, 101, and 201 alone. FIG. 3A illustrates a state immediately before the connector mounted body 1 is connected to the connector mounted bodies 101 and 201. FIG. 3B illustrates a state where all the connector mounted bodies 1, 101, and 201 are connected together. In FIGS. 3A and 3B, P1, P2, and P3 denote circuit boards provided to the connector mounted bodies 1, 101, and 201, respectively.

As illustrated in FIGS. 3A and 3B, the connector mounted body 1 includes the circuit board P1, a control connector pair, and a power connector pair. The circuit board P1 is placed in such a manner that plate surfaces thereof and the front-and-back direction (the Y-axis direction) form a right angle. The control connector pair is an electric connector pair mounted on a portion on a Z2 side (a lower portion in FIGS. 3A and 3B) of a mount surface (a plate surface on the Y2 side) of the circuit board P1. The power connector pair is an electric connector pair mounted on a portion on a Z1 side (an upper portion in FIGS. 3A and 3B) of the mount surface of the circuit board P1. The above control connector pair mainly supplies control signals to, for example, a servo amplifier. The above power connector pair mainly supplies power to, for example, a servomotor. Moreover, the control connector pair includes a control female connector 2 as a first connector, and a control male connector 3 as a second connector. The power connector pair includes a power male connector 4 as a first connector, and a power female connector 5 as a second connector.

As illustrated in FIGS. 3A and 3B, the control female connector 2 is provided on the X1 side (one side) of the circuit board P1 in the coupling direction. The control male connector 3 is provided on the X2 side (the other side) of the circuit board P1 in the coupling direction. The control female connector 2 and the control male connector 3 are electrically connected to each other by a circuit portion (not illustrated) formed on the circuit board P1. Moreover, the power male connector 4 is provided on the X1 side (the one side) of the circuit board P1 in the coupling direction. The power female connector 5 is provided on the X2 side (the other side) of the circuit board P1 in the coupling direction. The power male connector 4 and the power female connector 5 are electrically connected to each other by a circuit portion (not illustrated) formed on the circuit board P1.

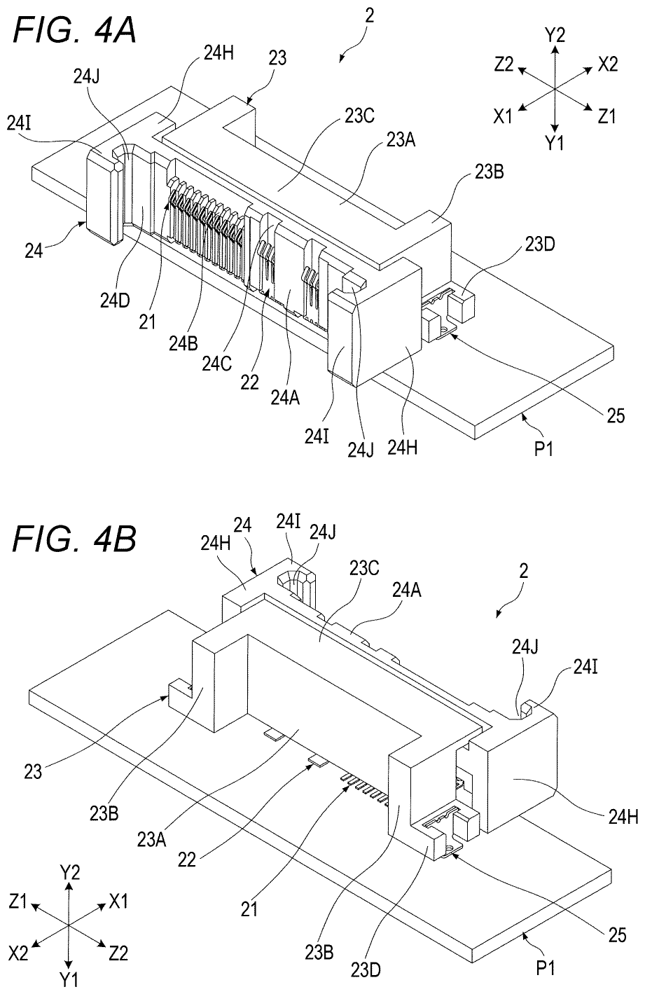

FIGS. 4A and 4B are perspective views of the control female connector 2 mounted on the circuit board P1. FIG. 4A illustrates a state of the control female connector 2 as viewed from the X1 side. FIG. 4A illustrates a state of the control female connector 2 as viewed from the X2 side. FIGS. 4A and 4B illustrate by example only a part of the circuit board P1, or more specifically, only a portion around the control female connector 2. The control female connector 2 includes a plurality of female terminals 21 and 22 as first terminals, housings 23 and 24 as first housings that hold the plurality of female terminals 21 and 22, and a fitting 25 that is held at each end portion of the fixed housing 23. Moreover, the female terminals 21 and 22 include a plurality of the signal female terminals 21 as first terminals for signals, and a plurality of the power female terminals 22 as first terminals for power. The housings 23 and 24 include the fixed housing 23 fixed to the circuit board P1 via the female terminals 21 and 22, and the moving housing 24 that is movable relative to the fixed housing 23.

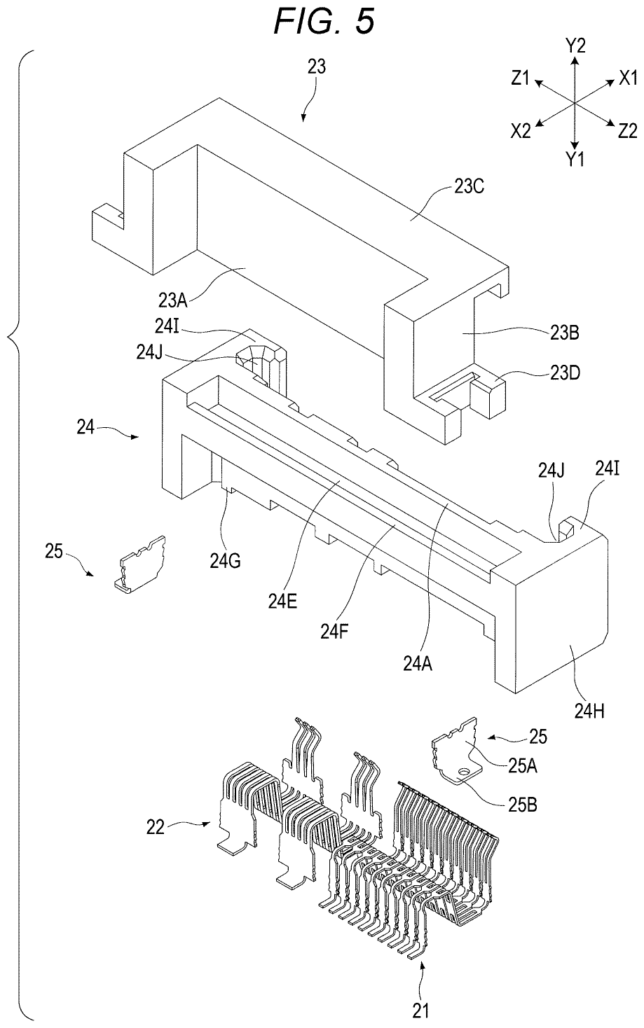

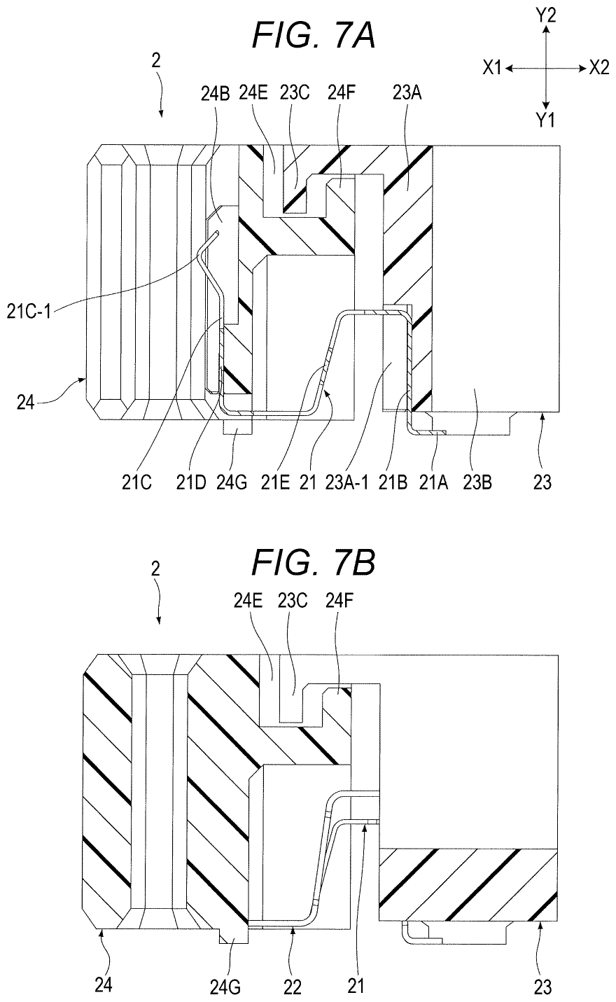

FIG. 5 is a perspective view illustrating members forming the control female connector 2, which are separated from one another. FIG. 6A is a perspective view of the signal female terminal 21. FIG. 6B is a perspective view of the power female terminal 22. FIG. 6C is a front view of the control female connector 2. FIGS. 7A and 7B are cross-sectional views of the control female connector 2, taken along planes perpendicular to a terminal arrangement direction. FIG. 7A illustrates a cross section of the control female connector 2 at a position of the signal female terminal 21. FIG. 7B illustrates a cross section of the control female connector 2 at a position of the power female terminal 22.

As illustrated in FIGS. 4A and 4B, FIG. 5, and FIG. 6C, the plurality of the signal female terminals 21 and the plurality of the power female terminals 22 are arranged, taking a direction (a Z-axis direction) perpendicular to both of the coupling direction (the X-axis direction) and the front-and-back direction (the Y-axis direction) as the terminal arrangement direction. Specifically, ten signal female terminals 21 are provided to a half portion on the Z2 side of the control female connector 2, and two power female terminals 22 are provided to a half portion on the Z1 side of the control female connector 2.

Each of the signal female terminals 21 is made by bending a metal strip-shaped piece (metal plate member) in its thickness direction. As illustrated in FIG. 4A, the signal female terminals 21 are partly accommodated in accommodating portions 23A-1 and 24B (the fixed-side accommodating portions 23A-1 and the moving-side accommodating portions 24B) formed in the housings 23 and 24, and therefore, are held by the accommodating portions 23A-1 and 24B. The signal female terminals 21 are press-fitted into and attached to the accommodating portions 23A-1 and 24B from the front (from below in FIGS. 4 to 7). As illustrated in FIG. 6A, the signal female terminal 21 includes a signal connection portion 21A provided on one end side of the signal female terminal 21, a fixed-side held portion 21B extending continuously from the signal connection portion 21A, two signal contact arm portions 21C provided on the other end side of the signal female terminal 21, a moving-side held portion 21D extending continuously from the signal contact arm portions 21C, and an elastic portion 21E that can deform elastically and is provided between the fixed-side held portion 21B and the moving-side held portion 21D.

The signal connection portion 21A extends toward X2 in the coupling direction (the X-axis direction), and is configured in such a manner as to be connectable by soldering to its corresponding circuit portion of the circuit board P1. The fixed-side held portion 21B is bent at an end portion on the X1 side of the signal connection portion 21A, and extends backward (toward Y2). The fixed-side held portion 21B is press-fitted into the respective fixed-side accommodating portion 23A-1 of the fixed housing 23, and is held at an edge portion on each side of the fixed-side held portion 21B in a terminal width direction, that is, the same direction (the Z-axis direction) as the terminal arrangement direction, by the respective fixed-side accommodating portion 23A-1.

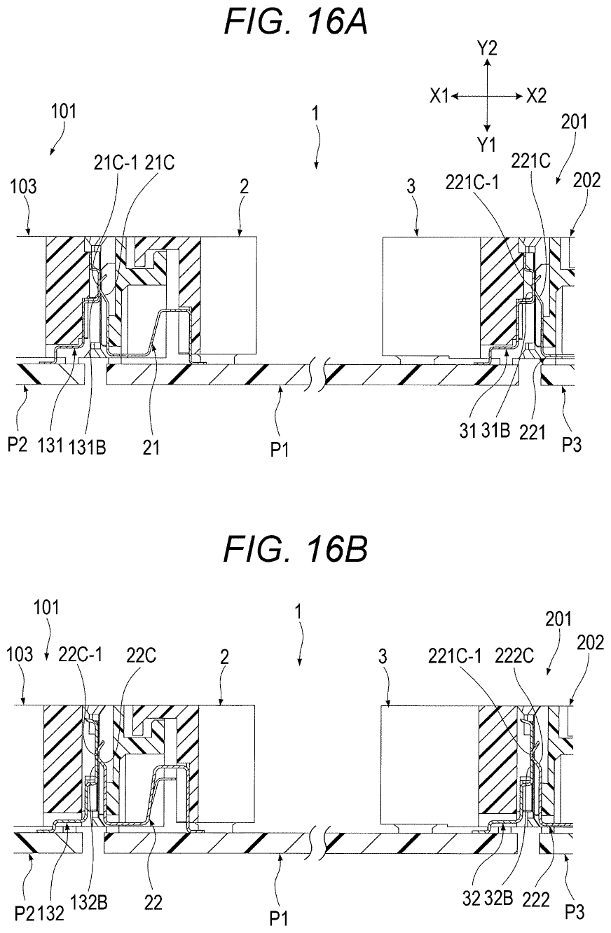

The two signal contact arm portions 21C extend in the front-and-back direction (an up-and-down direction (the Y-axis direction) in FIGS. 4 to 7) on the X1 side and on the Y2 side (backward) relative to the signal connection portion 21A. The signal contact arm portions 21C are configured in such a manner as to be elastically deformable in the thickness direction, that is, the coupling direction (the X-axis direction). A back end-side portion of each of the signal contact arm portions 21C is formed with a signal contact portion 21C-1 that is bent in such a manner as to protrude toward X1. Each of the signal contact arm portions 21C is configured in such a manner as to allow the signal contact portion 21C-1 to come into contact with a signal male terminal 131 of a control male connector 103 (a second mating connector) being a mating connector (refer to FIG. 16A). In the embodiment, a plurality of (two in the embodiment) the signal contact arm portions 21C with a small terminal width dimension is provided to facilitate elastic deformation of the signal contact arm portions 21C as compared to a case where one signal contact arm portion with a larger terminal width dimension is provided.

The moving-side held portion 21D extends forward (toward Y1) from front ends of the signal contact arm portions 21C. The moving-side held portion 21D is press-fitted into the respective moving-side accommodating portion 24B of the moving housing 24, and is held at an edge portion on each side of the moving-side held portion 21D in the terminal width direction by the respective moving-side accommodating portion 24B. As illustrated in FIG. 6A, the elastic portion 21E has an approximately crank shape as viewed in the terminal width direction. The elastic portion 21E couples a back end of the fixed-side held portion 21B and a front end of the moving-side held portion 21D. The elastic portion 21E can deform elastically in the coupling direction (the X-axis direction), the front-and-back direction (the Y-axis direction), and the terminal arrangement direction (the Z-axis direction). The elastic portion 21E deforms elastically to permit movement (floating) of the moving housing 24 relative to the fixed housing 23.

In the embodiment, a slit 21E-1 that penetrates the elastic portion 21E at the center position in the terminal width direction and extends in a longitudinal direction of the elastic portion 21E is formed in the elastic portion 21E in a plurality of places in the longitudinal direction. Each of the slits 21E-1 is formed in this manner to form portions with a small terminal width dimension across the slit 21E-1 in the terminal width direction. As a result, the elastic portion 21E is made easier to deform elastically than an elastic portion without slits.

Each of the power female terminals 22 is made by bending a metal strip-shaped piece in its thickness direction as in the signal female terminals 21. Each of the power female terminals 22 is held in accommodating portions (a fixed-side accommodating portion (not illustrated) and a moving-side accommodating portion 24C) formed in the housings 23 and 24 in such a manner as to be partly accommodated in the accommodating portions. The power female terminals 22 are press-fitted into and attached to power female terminal accommodating portions from the front (from below in FIGS. 4 to 7). The power female terminals 22 have a shape similar to the signal female terminals 21. As illustrated in FIG. 6B, the power female terminal 22 includes a power connection portion 22A provided on one end side of the power female terminal 22, a fixed-side held portion 22B extending continuously from the power connection portion 22A, three power contact arm portions 22C provided on the other end side of the power female terminal 22, a moving-side held portion 22D extending continuously from the power contact arm portions 22C, and an elastic portion 22E that can deform elastically and is provided between the fixed-side held portion 22B and the moving-side held portion 22D.

Here, the power female terminal 22 is described, focusing on points different from the signal female terminal 21. The power female terminal 22 is formed in such a manner as to be wider than the signal female terminal 21, that is, to have a larger terminal width dimension than the signal female terminal 21. Moreover, the fixed-side held portion 22B, the moving-side held portion 22D, and the elastic portion 22E are configured in such a manner as to be wider than the other portions of the power female terminal 22. The elastic portion 22E is penetrated at a plurality of positions in the terminal width direction. Furthermore, a slit 22E-1 that extends in a longitudinal direction of the elastic portion 22E is formed in a plurality of places in the longitudinal direction.

In the embodiment, the elastic portion 22E of the power female terminal 22 is formed to be longer than the elastic portion 21E of the signal female terminal 21. Therefore, even if the terminal width dimension of the elastic portion 22E of the power female terminal 22 is wide, it is still easy for the elastic portion 22E to deform elastically. As a result, the elastic portion 22E of the power female terminal 22 and the elastic portion 21E of the signal female terminal 21 can deform elastically at substantially the same level of springiness. Hence, the moving housing 24 can be smoothly floated.

In the embodiment, as illustrated in FIG. 6C, the signal contact portions 21C-1 and power contact portions 22C-1 are provided at the same position in the front-and-back direction (the Y-axis direction) in a state where the female terminals 21 and 22 are attached to the housings 23 and 24.

The fixed housing 23 is made of an electric insulating material such as resin. The fixed housing 23 includes a side wall 23A extending in the terminal arrangement direction, end walls 23B, a fixed-side restriction portion 23C, and fitting holding portions 23D as illustrated in FIGS. 4A and 4B and FIG. 5. The end wall 23B extends in the coupling direction toward X2 from each end portion of the side wall 23A in the terminal arrangement direction. The fixed-side restriction portion 23C extends out from a back end portion of the side wall 23A toward X1. The fitting holding portion 23D protrudes outward in the terminal arrangement direction from a front end portion of each of the end walls 23B.

A substantially half portion, which is on the Z2 side in the terminal arrangement direction, of the side wall 23A is formed with the fixed-side accommodating portions 23A-1 (refer to FIG. 7A) that each accommodate and hold the respective signal female terminal 21. A substantially half portion, which is on the Z1 side in the terminal arrangement direction, of the side wall 23A is formed with fixed-side power accommodating portions (not illustrated) that each accommodate and hold the respective power female terminal 22. The fixed-side accommodating portions 23A-1 and the fixed-side power accommodating portions are each formed as a groove portion that is recessed into a surface on the X1 side of the side wall 23A and is open at a front end (a lower end in FIG. 7A) thereof (refer to FIG. 7A). The fixed-side power accommodating portions are formed to be larger in the terminal arrangement direction, that is, wider, than the fixed-side accommodating portions 23A-1.

As illustrated in FIG. 5, the fixed-side restriction portion 23C is formed along the same length as the side wall 23A in the terminal arrangement direction. The fixed-side restriction portion 23C has an approximately horizontal L-shaped hook shape as viewed in the terminal arrangement direction. The fixed-side restriction portion 23C is configured in such a manner as to be capable of being latched in the coupling direction to a moving-side restricted portion 24F provided to the moving housing 24 by means of a portion at a distal end position on the X1 side of the fixed-side restriction portion 23C, the portion protruding forward (downward in FIG. 5). The fixed-side restriction portion 23C is configured in such a manner as to restrict equal to or greater than a predetermined quantity of movement of the moving housing 24. Each of the fitting holding portions 23D is configured in such a manner as to have a groove portion extending in the front-and-back direction, in which the respective fitting 25 is press-fitted and held.

The moving housing 24 is made of an electric insulating material such as resin. The moving housing 24 includes a side wall 24A that extends in the terminal arrangement direction, and an end wall 24H that is located at each end of the moving housing 24 in the terminal arrangement direction and is coupled by the side wall 24A. As illustrated in FIG. 4A, a substantially half portion, which is on the Z2 side in the terminal arrangement direction, of the side wall 24A is formed with the moving-side accommodating portions 24B that each accommodate and hold the respective signal female terminal 21. Moreover, a substantially half portion, which is on the Z1 side in the terminal arrangement direction, of the side wall 24A is formed with the moving-side accommodating portions 24C that each accommodate and hold the respective power female terminal 22.

As illustrated in FIG. 7A, the moving-side accommodating portions 24B are formed in such a manner as to be recessed into a side surface on the X1 side (a left surface in FIG. 7A), a front end surface (a lower surface in FIG. 7A), and a side surface on the X2 side (a right surface in FIG. 7A) of the side wall 24A. The moving-side accommodating portions 24C also have the same shape as the moving-side accommodating portions 24B as viewed in the terminal arrangement direction. However, the moving-side accommodating portions 24C are formed to be larger in the terminal arrangement direction, that is, wider than the moving-side accommodating portions 24B.

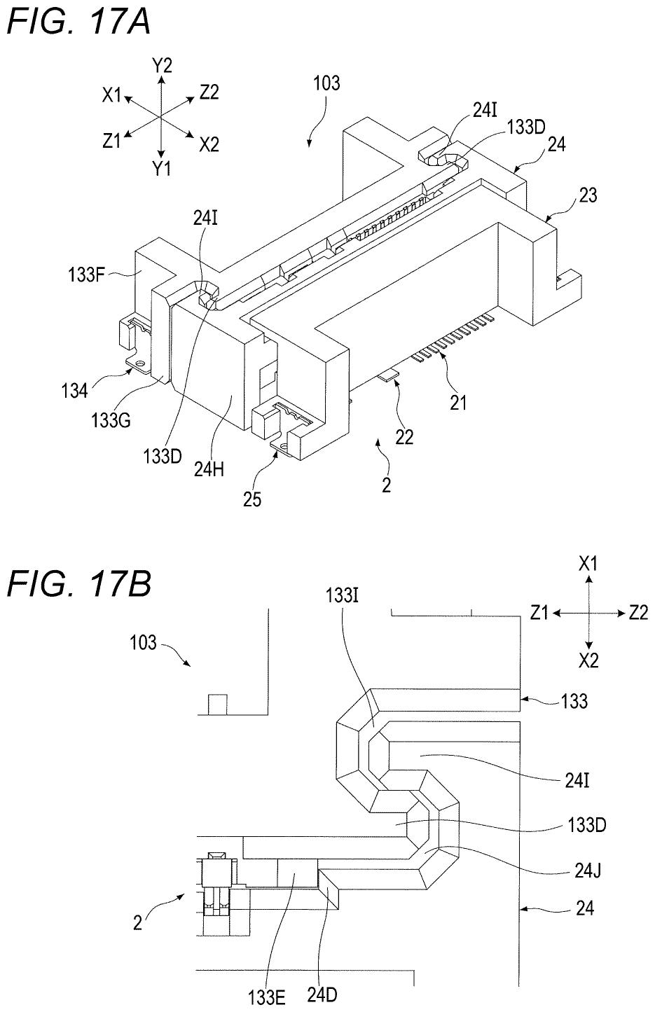

As illustrated in FIG. 4A, the side wall 24A has stepped portions, and the stepped portions protrude from the surface on the X1 side of the side wall 24A and extend in the front-and-back direction, at positions outside the terminal arrangement area in the terminal arrangement direction. The stepped portions are female-side abutting portions 24D as first abutting portions. An edge portion, which is located inward in the terminal arrangement direction, of each of the female-side abutting portions 24D extends in a straight line throughout its length in the front-and-back direction. The female-side abutting portions 24D are each configured in such a manner as to be capable of being latched to a male-side abutting portion 133E provided to the control male connector 103 being the mating connector by abutting above edge portions against the male-side abutting portions 133E in the terminal arrangement direction (refer to FIG. 17B).

As illustrated in FIG. 5, a recessed portion 24E that receives the fixed-side restriction portion 23C is formed in a portion on the X2 side of the side wall 24A in such a manner as to be recessed into a back surface (a surface on the Y2 side) of the side wall 24A and extend in the terminal arrangement direction. The recessed portion 24E is recessed in such a manner as to have a shape fitting the fixed-side restriction portion 23C of the fixed housing 23, that is, an approximately horizontal L shape as viewed in the terminal arrangement direction. An edge portion on the X2 side of the side wall 24A, that is, a portion of the side wall 24A that extends in the terminal arrangement direction along the recessed portion 24E and is erected backward (toward the Y2 side), is the moving-side restricted portion 24F. The moving-side restricted portion 24F is configured in such a manner as to be capable of being latched in the coupling direction to the fixed-side restriction portion 23C of the fixed housing 23. The moving housing 24 is configured in such a manner as to be subjected to a restriction on equal to or greater than a predetermined quantity of movement in the coupling direction by latching the moving-side restricted portion 24F to the fixed-side restriction portion 23C. As a result, the moving-side restricted portion 24F stays within a predetermined area in the coupling direction. Hence, it is possible to avoid excessive deformation of the elastic portions 21E and 22E of the female terminals 21 and 22 by excessive movement of the moving housing 24 in the coupling direction.

The side wall 24A includes projection-like moving-side restriction portions 24G. The moving-side restriction portion 24G protrudes forward, that is, toward the mount surface of the circuit board P1, from a front surface (a surface on the Y1 side) of the side wall 24A, at a position near each end of the side wall 24A in the terminal arrangement direction. The moving-side restriction portions 24G are configured in such a manner as to be capable of coming into contact with the mount surface. The moving-side restriction portions 24G are provided in this manner, and therefore, the moving housing 24 is subjected to restriction of the position in the front-and-back direction (the Y-axis direction). Accordingly, it is possible to stabilize the position of the moving housing 24, and by extension of the female terminals 21 and 22.

As illustrated in FIG. 4A, a substantially half portion, which is on the X1 side in the coupling direction, of each of the end walls 24H is formed as a female-side latch portion 24I as a first latch portion that protrudes toward X1 relative to the side wall 23A and extends in the front-and-back direction. The female-side latch portions 24I extend uniformly throughout their length in the front-and-back direction (the Y-axis direction). Each of the female-side latch portions 24I has an approximately L-shaped hook shape in cross section along a plane perpendicular to the front-and-back direction. As illustrated in FIGS. 4A and 4B, each of the female-side latch portions 24I is configured in such a manner that a portion, which protrudes inward in the terminal arrangement direction, of a distal end portion thereof on the X1 side in the coupling direction can be latched in the coupling direction to a male-side latch portion 133D provided to the control male connector 103 being the mating connector (refer also to FIGS. 17A and 17B). Moreover, as illustrated in FIGS. 4A and 4B, a recessed portion 24J is formed inside an approximately L-shaped inner edge of each of the female-side latch portions 24I. The recessed portions 24J are open inward in the terminal arrangement direction, and penetrate and extend in the up-and-down direction.

As illustrated in FIG. 5, each of the fittings 25 is made by bending a metal plate member in its thickness direction, and includes a held portion 25A and a fixed portion 25B. Each of the held portions 25A has a plate surface perpendicular to the terminal arrangement direction, and extends in the front-and-down direction (the up-and-down direction in FIG. 5). Each of the fixed portions 25B is bent at a front end (a lower end in FIG. 5) of the respective held portion 25A, and extends outward in the terminal arrangement direction. Each of the held portions 25A is press-fitted into the respective fitting holding portion 23D from the back (from above in FIG. 5), and two side edge portions (edge portions extending in the front-and-back direction) of each of the held portions 25A are held by the respective fitting holding portion 23D. Each of the fixed portions 25B is configured in such a manner as to be fixed and connected by soldering to its corresponding portion of the circuit board P1.

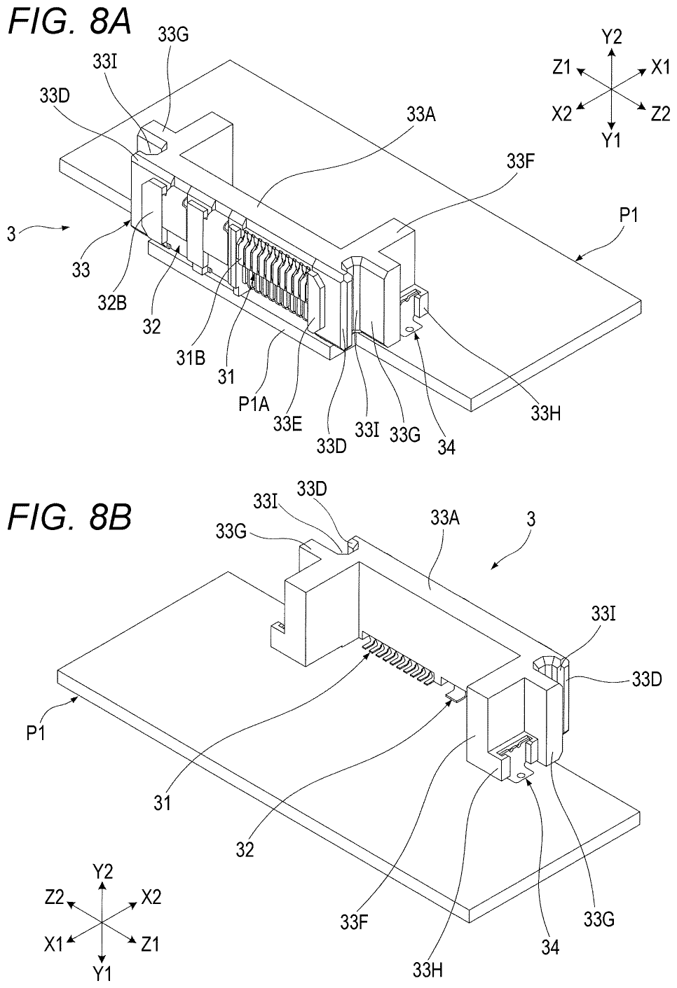

FIGS. 8A and 8B are perspective views of the control male connector 3 mounted on the circuit board P1. FIG. 8A illustrates a state of the control male connector 3 as viewed from the X2 side. FIG. 8B illustrates a state of the control male connector 3 as viewed from the X1 side. FIGS. 8A and 8B illustrate by example only a part of the circuit board P1, or more specifically, only a portion around the control male connector 3. As illustrated in FIG. 8A, a part of the circuit board P1 protrudes to form a protruding portion P1A at an end portion on the X2 side of the circuit board P1. The protruding portion P1A supports a portion on the X2 side of the control male connector 3 from the front (the Y1 side).

The control male connector 3 includes a plurality of male terminals 31 and 32 as second terminals, a housing 33 as a second housing that holds the plurality of male terminals 31 and 32, and a fitting 34 held at each end portion of the housing 33. Moreover, the male terminals 31 and 32 include a plurality of the signal male terminals 31 as second terminals for signals, and a plurality of the power male terminals 32 as second terminals for power.

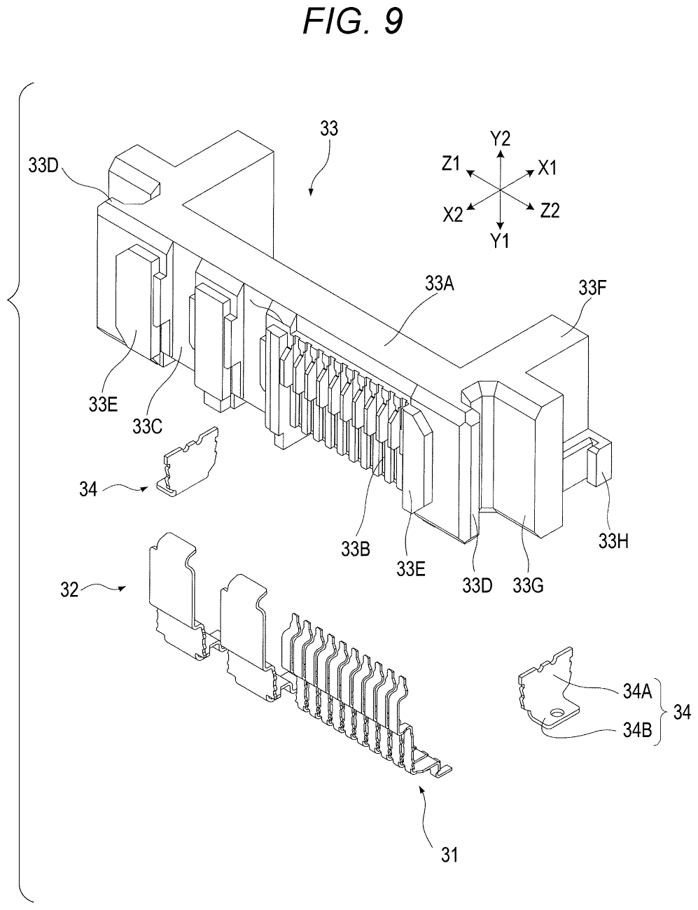

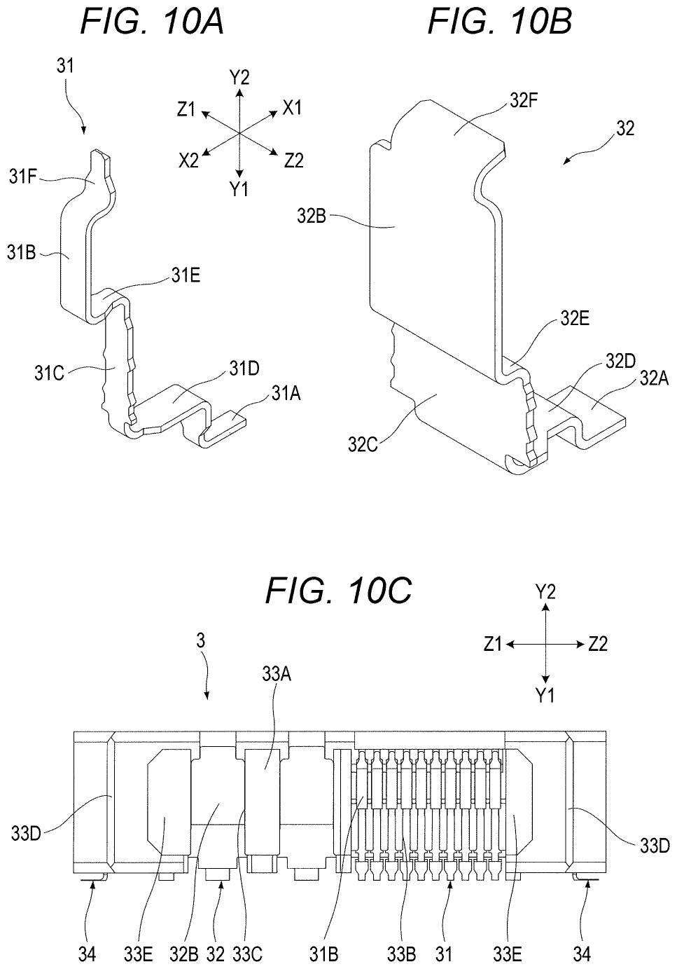

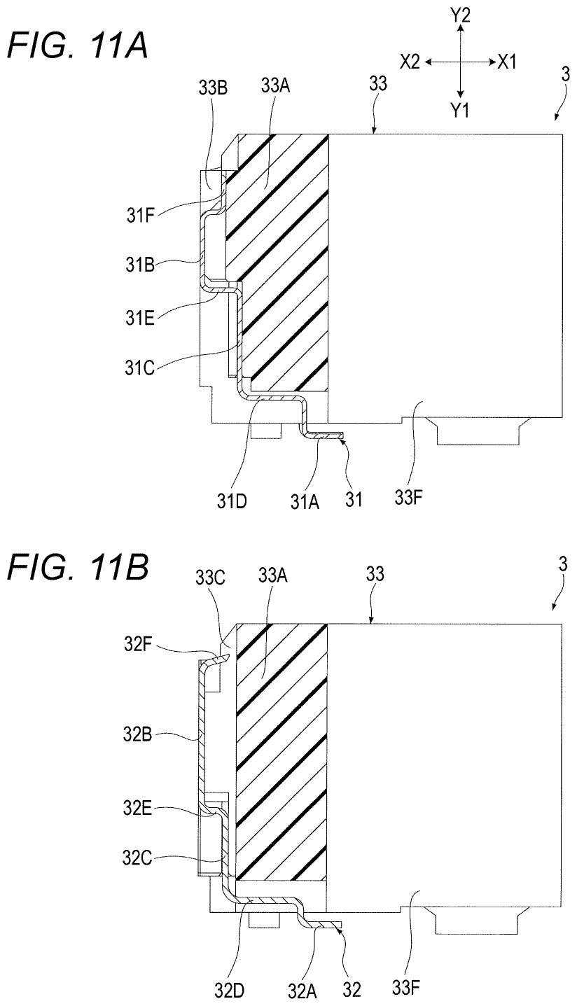

FIG. 9 is a perspective view illustrating members forming the control male connector 3, which are separated from one another. FIG. 10A is a perspective view of the signal male terminal 31. FIG. 10B is a perspective view of the power male terminal 32. FIG. 10C is a front view of the control male connector 3. FIGS. 11A and 11B are cross-sectional views of the control male connector 3, taken along planes perpendicular to the terminal arrangement direction. FIG. 11A illustrates a cross section of the control male connector 3 at a position of the signal male terminal 31. FIG. 11B illustrates a cross section of the control male connector 3 at a position of the power male terminal 32.

As illustrated in FIGS. 8A and 8B, FIG. 9, and FIG. 10C, the plurality of the signal male terminals 31 and the plurality of the power male terminals 32 are arranged, taking a direction (the Z-axis direction) perpendicular to both of the coupling direction (the X-axis direction) and the front-and-back direction (the Y-axis direction) as the terminal arrangement direction. Specifically, ten signal male terminals 31 are provided to a half portion on the Z2 side of the control male connector 3, and two power male terminals 32 are provided to a half portion on the Z1 side, as illustrated in FIG. 8A.

As illustrated in FIG. 8A, each of the signal male terminals 31 is made by bending a metal strip-shaped piece (metal plate member) in its thickness direction. Th signal male terminals 31 are press-fitted into accommodating portions 33B formed in the housing 33 from the front (from below in FIGS. 8 to 11), and therefore, are accommodated and held in the accommodating portions 33B. As illustrated in FIG. 10A, each of the signal male terminals 31 includes a signal connection portion 31A provided on one end side of the signal male terminal 31, a signal contact portion 31B provided on the other end side of the signal male terminal 31, a held portion 31C provided between the signal connection portion 31A and the signal contact portion 31B in a longitudinal direction of the signal male terminal 31, a front transition portion 31D provided between the signal connection portion 31A and the held portion 31C, a back transition portion 31E provided between the signal contact portion 31B and the held portion 31C, and a free end portion 31F extending from a back end of the signal contact portion 31B.

The signal connection portion 31A extends toward X1 in the coupling direction (the X-axis direction), and is configured in such a manner as to be connectable by soldering to its corresponding circuit portion of the circuit board P1. The signal contact portion 31B extends in the front-and-back direction (the up-and-down direction in FIG. 8A), backward (upward in FIG. 8A) of the signal connection portion 31A. The signal contact portion 31B is located on the X2 side relative to the other portions of the signal male terminal 31. The signal contact portion 31B is configured in such a manner as to be capable of coming into contact with a signal female terminal 221 provided to a control female connector 202 (a first mating connector) being a mating connector with a plate surface on the X2 side of the signal contact portion 31B as a contact surface (refer to FIG. 16A).

In the embodiment, the plate surface on the X2 side, put another way, the plate surface perpendicular to the coupling direction, of the signal contact portion 31B is the contact surface. Hence, a sufficiently large area can be secured for the contact surface. Moreover, the dimension of the signal contact portion 31B in the coupling direction is the thickness dimension of the signal contact portion 31B. Hence, the dimension of the signal contact portion 31B in the coupling direction can be reduced. Therefore, the depth, that is, the dimension in the coupling direction, of a recessed portion that accommodates the signal contact portion 31B of the housing 33 can be reduced. Hence, the shape of the housing 33 can be made simple. Therefore, sufficient strength can be secured for the housing 33.

The held portion 31C is located in the coupling direction between the signal connection portion 31A and the signal contact portion 31B, and is located also in the front-and-back direction between the signal connection portion 31A and the signal contact portion 31B. The held portion 31C is press-fitted into the accommodating portion 33B of the housing 33, and is held at an edge portion on each side of the held portion 31C in the terminal width direction, that is, the same direction (the Z-axis direction) as the terminal arrangement direction.

The front transition portion 31D is bent in an approximately horizontal L shape as viewed in the terminal width direction. The front transition portion 31D couples a front end (a lower end in FIG. 8A) of the held portion 31C, and an end portion on the X2 side of the signal connection portion 31A. The back transition portion 31E extends in the coupling direction (the X-axis direction), and couples a front end of the signal contact portion 31B and a back end of the held portion 31C. The free end portion 31F is a portion that is continuous with the back end of the signal contact portion 31B and extends up to a free end on one end side of the signal male terminal 31. A coupled portion of the free end portion 31F with the back end of the signal contact portion 31B bends toward an opposite side to the contact surface of the signal contact portion 31B in the X1 direction, that is, in the coupling direction. The entire shape of the free end portion 31F has an approximately L shape as viewed in the terminal width direction.

As illustrated in FIG. 11A, the back end (free end) of the free end portion 31F is located in the accommodating portion 33B. Hence, a signal female terminal of the control female connector 202 is prevented from coming into contact (interfering) with the back end of the free end portion 31F in the course of the operation of mating to the control female connector 202 (refer to FIGS. 3A and 3B) being the mating connector. Therefore, it is possible to excellently avoid damage caused by buckling of a part of the signal male terminal 31 due to interference of the above signal female terminal with the back end of the free end portion 31F after start of the mating operation.

Each of the power male terminals 32 is made by bending a metal strip-shaped piece in its thickness direction as in the signal male terminals 31. As illustrated in FIG. 8A, the power male terminals 32 are accommodated and held in accommodating portions 33C formed in the housing 33. The power male terminals 32 are each press-fitted into the respective accommodating portion 33C from the front (from below in FIGS. 8 to 11) and therefore are attached therein. The power male terminals 32 have a shape similar to the signal male terminals 31. As illustrated in FIG. 10B, each of the power male terminals 32 includes a power connection portion 32A provided on one end side of the power male terminal 32, a power contact portion 32B provided on the other end side of the power male terminal 32, a held portion 32C provided between the power connection portion 32A and the power contact portion 32B in a longitudinal direction of the power male terminal 32, a front transition portion 32D provided between the power connection portion 32A and the held portion 32C, a back transition portion 32E provided between the power contact portion 32B and the held portion 32C, and a free end portion 32F extending from a back end of the power contact portion 32B.

Here, the power male terminal 32 is described, focusing on points different from the signal male terminal 31. The power male terminal 32 is formed to be wider, that is, to have a larger terminal width dimension, than the signal male terminal 31. Moreover, the power contact portion 32B, the held portion 32C, and the back transition portion 32E are configured to be wider than the other portions of the power male terminal 32. A coupled portion of the free end portion 32F with the back end of the power contact portion 32B bends in the X1 direction, and extends in such a manner as to incline upward increasingly toward X1 (refer also to FIG. 11B).

As illustrated in FIG. 11B, a back end (free end) of the free end portion 32F is located in the accommodating portion 33C. Hence, the power female terminal of the control female connector 202 is prevented from coming into contact (interfering) with the back end of the free end portion 32F in the course of the operation of mating to the control female connector 202 (refer to FIGS. 3A and 3B) being the mating connector. Therefore, it is possible to excellently avoid damage caused by buckling of a part of the power male terminal 32 due to the interference of the above power female terminal with the back end of the free end portion 32F after the start of the mating operation.

Moreover, as illustrated in FIG. 10C, each of the power contact portions 32B extends throughout its length including the length of the signal contact portion 31B in the front-and-back direction (the up-and-down direction in FIG. 10C). Put another way, front ends (lower ends in FIG. 10C) of the power contact portions 32B are located forward of front ends of the signal contact portions 31B, and the back ends (upper ends in FIG. 10C) of the power contact portions 32B are located backward of the back ends of the signal contact portions 31B.

The housing 33 is made of an electric insulating material such as resin. As illustrated in FIGS. 8A and 8B and FIG. 9, the housing 33 includes a side wall 33A extending in the terminal arrangement direction, end walls 33F, jutting portions 33G, and fitting holding portions 33H. The end wall 33F extends in the coupling direction toward X1 from each end portion in the terminal arrangement direction of the side wall 33A. The jutting portions 33G jut out in the terminal arrangement direction from outer side surfaces of the end walls 33F. The fitting holding portions 33H protrude outward in the terminal arrangement direction from outer side surfaces of front end portions of the end walls 33F on the X1 side relative to the jutting portions 33G. A substantially half portion, which is on the Z2 side in the terminal arrangement direction, of the side wall 33A is formed with the accommodating portions 33B (refer to FIG. 11A) that each accommodate and hold the respective signal male terminal 31. A substantially half portion, which is on the Z1 side in the terminal arrangement direction, of the side wall 33A is formed with the accommodating portions 33C (refer to FIG. 11B) that each accommodate and hold the respective power male terminal 32.

As illustrated in FIGS. 11A and 11B, the accommodating portion 33B and the accommodating portion 33C are formed in such a manner as to be recessed into a front surface (a lower surface in FIGS. 11A and 11B) and a surface on the X2 side of the side wall 33A. The accommodating portion 33B and the accommodating portion 33C are formed as recessed portions having an approximately L shape as viewed in the terminal arrangement direction. The accommodating portion 33C is formed to be larger in the terminal arrangement direction, that is, wider, than the accommodating portion 33B.

The side wall 33A includes a male-side latch portion 33D as a second latch portion, on each end thereof in the terminal arrangement direction. As illustrated in FIGS. 8A and 8B, the male-side latch portions 33D are formed as ridge portions that protrude outward in the terminal arrangement direction (the Z-axis direction) and extend in the front-and-back direction (the Y-axis direction), in a portion on the X2 side of the side wall 33A in its thickness direction (the X-axis direction), that is, the coupling direction. The male-side latch portions 33D extend uniformly in straight lines throughout their length in the front-and-back direction. The male-side latch portions 33D are configured in such a manner as to be capable of being latched in the coupling direction to female-side latch portions provided to the control female connector 202 (refer to FIGS. 3A and 3B) being the mating connector. As illustrated in FIGS. 8A and 8B, recessed portions 33I are each formed between the male-side latch portion 33D and the jutting portion 33G. The recessed portions 33I are open outward in the terminal arrangement direction, and penetrate and extend in the up-and-down direction.

Moreover, the side wall 33A includes protruding portions that protrude from a surface on the X2 side of the side wall 33A and extend in the front-and-back direction, at positions outside the terminal arrangement area in the terminal arrangement direction. The protruding portions are male-side abutting portions 33E as second abutting portions. An edge portion, which is located furthest from the center in the terminal arrangement direction, of each of the male-side abutting portions 33E extends in a straight line throughout its length in the front-and-back direction. The male-side abutting portions 33E are configured in such a manner as to be capable of being latched to female-side abutting portions provided to the control female connector 202 (refer to FIGS. 3A and 3B) being the mating connector at the above edge portions by abutting against the female-side abutting portions in the terminal arrangement direction. Each of the fitting holding portions 33H is configured in such a manner as to have a groove portion extending in the front-and-back direction, in which the respective fitting 34 is press-fitted and held.

Each of the fittings 34 is made by bending a metal plate member in its thickness direction. Each of the fittings 34 includes a held portion 34A and a fixed portion 34B. Each of the held portions 34A has a plate surface perpendicular to the terminal arrangement direction, and extends in the front-and-down direction (the up-and-down direction in FIG. 9). Each of the fixed portions 34B bends at a front end (a lower end in FIG. 9) of the respective held portion 34A, and extends outward in the terminal arrangement direction. Each of the held portions 34A is press-fitted into the respective fitting holding portion 33H from the back (from above in FIG. 9), and its side edge portions (edge portions extending in the front-and-back direction) are held by the respective fitting holding portion 33H. The fixed portions 34B are configured in such a manner as to be fixed and connected by soldering to their corresponding portions of the circuit board P1.

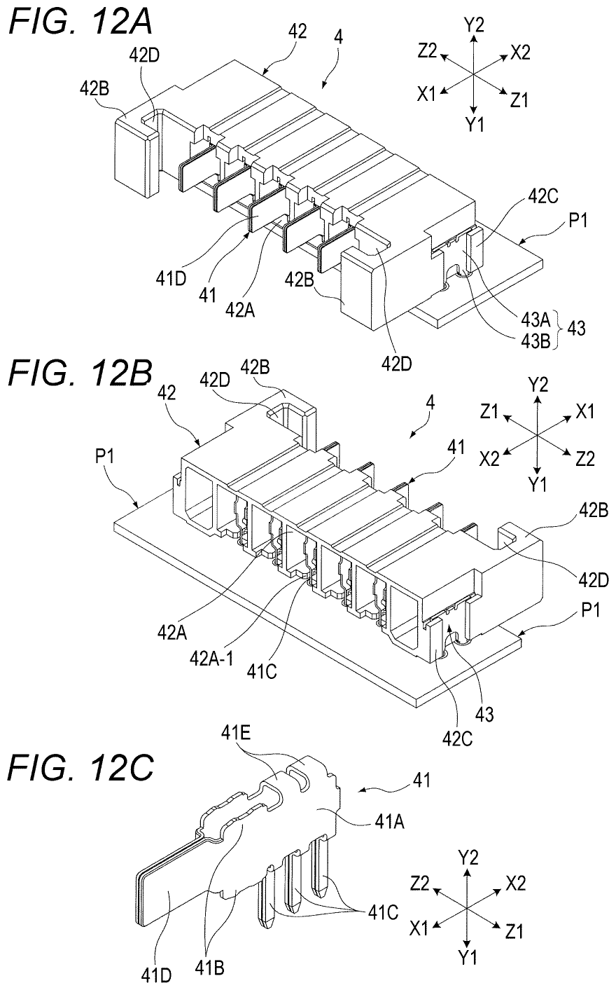

FIGS. 12A and 12B are perspective views of the power male connector 4 mounted on the circuit board P1. FIG. 12A illustrates a state of the power male connector 4 as viewed from the X1 side. FIG. 12B illustrates a state of the power male connector 4 as viewed from the X2 side. FIG. 12C is a perspective view of a power male terminal 41 of the power male connector 4, and illustrates a state of the power male connector 4 as viewed from the X1 side. Moreover, FIGS. 12A and 12B illustrate by example only a part of the circuit board P1, or more specifically, only a portion around the power male connector 4.

As illustrated in FIGS. 12A and 12B, in a state where the power male connector 4 is mounted on the circuit board P1, an end portion on the X1 side of the power male connector 4 in the coupling direction (the X-axis direction) protrudes toward X1 beyond an edge of the circuit board P1. The power male connector 4 includes a plurality of the power male terminals 41 as first terminals, a housing 42 as a first housing that holds the plurality of the power male terminals 41, and a fitting 43 held at each end portion of the housing 42.

As illustrated in FIGS. 12A and 12B, the plurality of the power male terminals 41 is arranged, taking, as the terminal arrangement direction, a direction (the Z-axis direction) perpendicular to both of the coupling direction (the X-axis direction) and the front-and-back direction (the Y-axis direction). Specifically, five power male terminals 41 are placed at even intervals. As illustrated in FIGS. 12A and 12B, the power male terminals 41 are accommodated and held in power male terminal accommodating portions 42A formed in the housing 42.

As illustrated in FIG. 12C, the power male terminal 41 is made by bending a metal strip-shaped piece in half in its thickness direction in such a manner that the halves are placed above one another in the terminal arrangement direction (the Z-axis direction). The power male terminal 41 includes base portions 41A, held portions 41B, power connection portions 41C, a power contact portion 41D, and a coupling portion 41E. The base portions 41A are formed as plate-shaped portions perpendicular to the Z-axis direction. Two base portions 41A are provided, facing each other and being spaced apart in the Z-axis direction. The held portions 41B protrude forward from a front end portion (a lower end portion in FIG. 12C) of a portion on the X1 side of each of the base portions 41A, and protrude backward from a back end portion (an upper end portion in FIG. 12C) of the portion. The power male terminals 41 are configured in such a manner as to be press-fitted from the X2 side into the power male terminal accommodating portions 42A formed in the housing 42 and held at the held portions 41B.

The power connection portions 41C extend forward from a front end portion of each of the base portions 41A, and are provided at three positions in the coupling direction (the X-axis direction), respectively. Coupled portions of the front end portions of the base portions 41A and the power connection portions 41C are bent in a crank shape. Consequently, each two plate-shaped portions come into surface contact with and are placed on each other to form one power connection portion 41C. The power connection portions 41C are configured in such a manner as to be cable of being inserted through their corresponding hole-like circuit portions formed in the circuit board P1 and connected by soldering to their corresponding circuit portions.

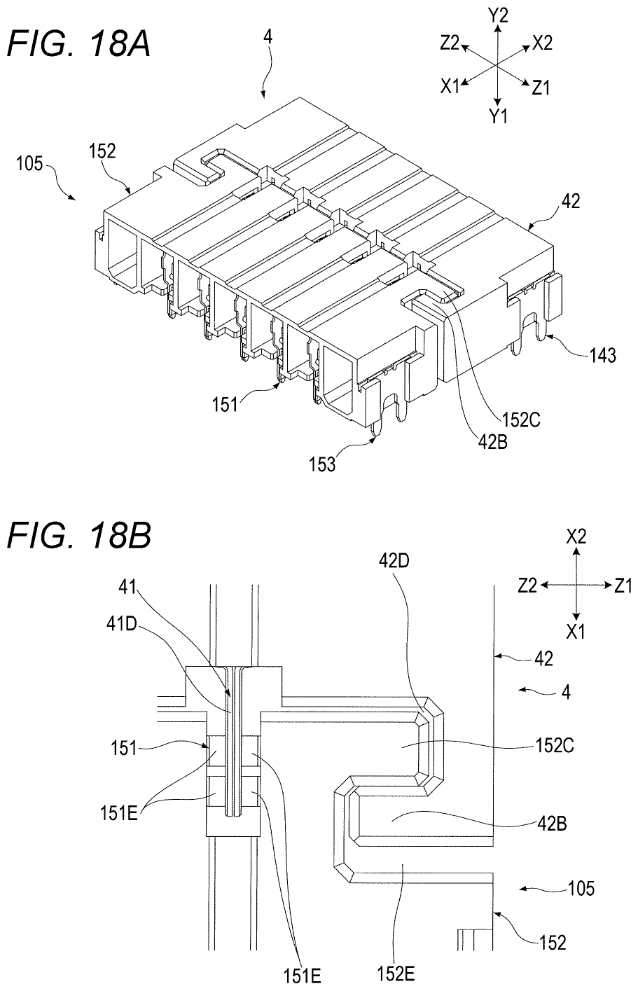

The power contact portion 41D extends from the base potions 41A toward X1. Coupled portions of end portions on the X1 side of the base portions 41A and the power contact portion 41D are bent in a crank shape. Consequently, two plate-shaped portions come into surface contact with and are placed on each other to form one power contact portion 41D. Outer plate surfaces of the power contact portion 41D serve as contact surfaces with a mating terminal (a power female terminal 151 provided to a power female connector 105) (refer to FIG. 18B). The coupling portion 41E couples back end portions of the two base portions 41A at two positions in the coupling direction (the X-axis direction).

The housing 42 is made of an electric insulating material such as resin. As illustrated in FIGS. 12A and 12B, the housing 42 has an approximately rectangular parallelepiped outer shape with the terminal arrangement direction as the longitudinal direction. The power male terminal accommodating portions 42A that each accommodate and hold the respective power male terminal 41, which are arranged in the terminal arrangement direction, are formed in the housing 42. Each of the power male terminal accommodating portions 42A is formed as a hole portion having an approximately rectangular cross-section that extends in the coupling direction (the X-axis direction) and penetrates the housing 42. As illustrated in FIG. 12B, a front wall portion (a wall portion facing the circuit board P1), which forms the power male terminal accommodating portions 42A, of the housing 42 is formed with slits 42A-1 extending in the coupling direction (the X-axis direction) in an area on the X2 side.

As already described, each of the power male terminals 41 is press-fitted into the respective power male terminal accommodating portion 42A from the X2 side in the coupling direction, and held at the respective held portions 41B. As illustrated in FIG. 12A, in a state where the power male terminals 41 are attached to the power male terminal accommodating portions 42A, the power contact portions 41D protrude from the power male terminal accommodating portions 42A toward X1. Moreover, as illustrated in FIG. 12B, the power connection portions 41C enter the slits 42A-1 of the housing 42 from the X2 side, and extend out forward from a front surface of the housing 42.

An end portion on the X1 side and on each end side in the terminal arrangement direction of the housing 42 includes a male-side latch portion 42B as a first latch portion. The male-side latch portion 42B is provided on each side outside the arrangement area of the power male terminals 41 in such a manner as to protrude toward X1 and extend in the front-and-back direction. The male-side latch portions 42B extend uniformly throughout their length in the front-and-back direction (the Y-axis direction). Each of the male-side latch portions 42B has an approximately L-shaped hook shape in cross section along a plane perpendicular to the front-and-back direction. The male-side latch portions 42B are configured in such a manner that portions, which protrude inward in the terminal arrangement direction, of their respective distal end portions on the X1 side in the coupling direction can be latched in the coupling direction to female-side latch portions 152C provided to the power female connector 105 being the mating connector (refer to FIGS. 18A and 18B). Moreover, as illustrated in FIGS. 12A and 12B, a recessed portion 42D is formed inside an approximately L-shaped inner edge of each of the male-side latch portions 42B. The recessed portions 42D are open inward in the terminal arrangement direction, and penetrate and extend in the up-and-down direction.

An end surface in the terminal arrangement direction of each end portion on the X2 side of the housing 42 is formed with a fitting holding portion 42C that holds the respective fitting 43. Each of the fitting holding portions 42C is configured in such a manner as to have a groove portion extending in the front-and-back direction, in which the respective fitting 43 is press-fitted and held.

Each of the fittings 43 is made by punching a metal plate member in its thickness direction. The fittings 43 have a plate shape having a plate surface perpendicular to the terminal arrangement direction. Each of the fittings 43 includes a held portion 43A and two fixed portions 43B extending forward from a front end of the held portion 43A. Each of the held portions 43A is press-fitted into the respective fitting holding portion 42C from the back, and therefore, each side edge portion (each edge portion extending in the front-and-back direction) of the held portion 43A is held by the respective fitting holding portion 42C. Each of the fixed portions 43B is inserted through its corresponding hole-like portion formed in the circuit board P1 and fixed and connected by soldering to the corresponding portion.

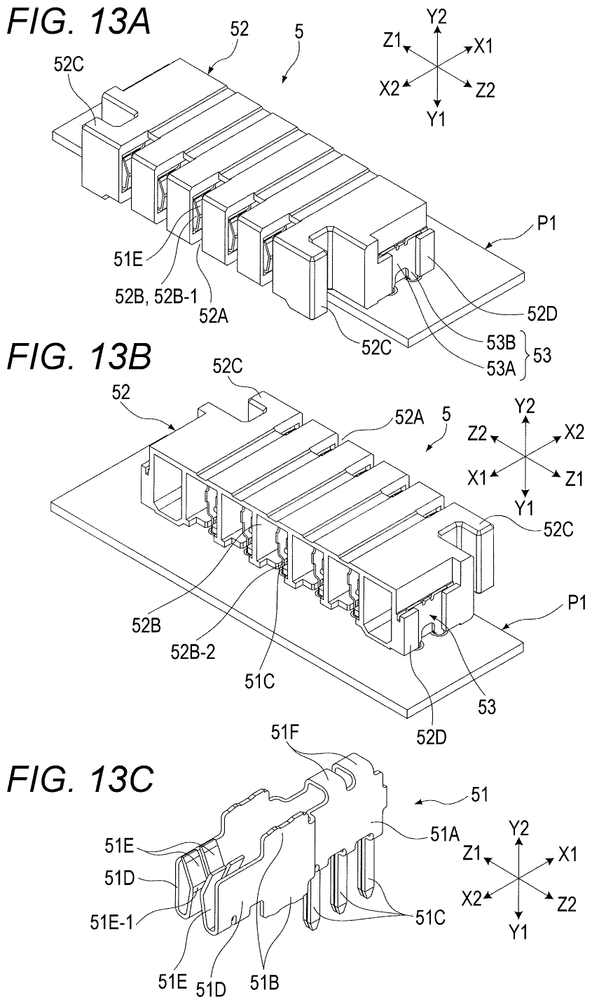

FIGS. 13A and 13B are perspective views of the power female connector 5 mounted on the circuit board P1. FIG. 13A illustrates a state of the power female connector 5 as viewed from the X2 side. FIG. 13B illustrates a state of the power female connector 5 as viewed from the X1 side. FIG. 13C is a perspective view of a power female terminal 51 of the power female connector 5, and illustrates a state of the power female terminal 51 as viewed from the X2 side. Moreover, FIGS. 13A and 13B illustrate by example only a part of the circuit board P1, or more specifically, only a portion around the power female connector 5.

As illustrated in FIGS. 13A and 13B, in a state where the power female connector 5 is mounted on the circuit board P1, an end portion on the X2 side of the power female connector 5 in the coupling direction (the X-axis direction) protrudes toward X2 beyond an edge of the circuit board P1. The power female connector 5 includes a plurality of the power female terminals 51 as second terminals, a housing 52 as a second housing that holds the plurality of the power female terminals 51, and a fitting 53 held at each end portion of the housing 52.

As illustrated in FIGS. 13A and 13B, the plurality of the power female terminals 51 is arranged, taking, as the terminal arrangement direction, a direction (the Z-axis direction) perpendicular to both of the coupling direction (the X-axis direction) and the front-and-back direction (the Y-axis direction). Specifically, five power female terminals 51 are placed at even intervals. As illustrated in FIGS. 13A and 13B, the power female terminals 51 are accommodated and held in accommodating portions 52B formed in the housing 52.

As illustrated in FIG. 13C, the power female terminal 51 is made by bending a metal strip-shaped piece in half in its thickness direction in such a manner that the halves are placed above one another in the terminal arrangement direction (the Z-axis direction). The power female terminal 51 includes base portions 51A, held portions 51B, power connection portions 51C, extension portions 51D, power contact arm portions 51E, and a coupling portion 51F. The base portions 51A are formed as plate-shaped portions perpendicular to the Z-axis direction. Two base portions 51A are provided, facing each other and being spaced apart in the Z-axis direction. Each of the two base portions 51A is bent in a crank shape at the middle position in the coupling direction (the X-axis direction). The spacing between the base portions 51A in an area on the X2 side is larger than the spacing between the base portions 51A in an area on the X1 side. The held portions 51B protrude forward from a front end portion (a lower end portion in FIG. 13C) of a portion on the X2 side of each of the base portions 51A, and protrude backward from a back end portion (an upper end portion in FIG. 13C) of the portion. The power female terminals 51 are configured in such a manner as to be press-fitted from the X1 side into the accommodating portions 52B formed in the housing 52 and held at the held portions 51B.

The power connection portions 51C extend forward from front end portions of the base portions 51A, and are provided at three positions in the coupling direction (the X-axis direction), respectively. Coupled portions of the front end portions of the base portions 51A and the power connection portions 51C are bent in a crank shape. Consequently, each two plate-shaped portions come into surface contact with and are placed on each other to form one power connection portion 51C. The power connection portions 51C are configured in such a manner as to be cable of being inserted through their corresponding hole-like circuit portions formed in the circuit board P1 and connected by soldering to the corresponding circuit portions.

Each of the extension portions 51D extends from the respective base portion 51A toward X2 without being bent. Each of the power contact arm portions 51E is folded back on itself from a front end portion of the respective extension portion 51D and extends backward. The power contact arm portions 51E are configured in such a manner as to be elastically deformable in the terminal arrangement direction. Two power contact arm portions 51E are located between two extension portions 51D in the terminal arrangement direction. Each of the power contact arm portions 51E is formed with a power contact portion 51E-1 at the middle position in the front-and-back direction (the up-and-down direction in FIG. 13C). The power contact portions 51E-1 are portions that are bent and protrude in the terminal arrangement direction in such a manner as to bring them closer to each other. Two power contact portions 51E-1 are configured in such a manner as to compress a power contact portion 241D (refer to FIG. 1A) of a power male terminal 241 provided to a power male connector 204 being a mating connector, in the terminal arrangement direction, and come into contact with the power contact portion 241D. The coupling portion 51F couples back end portions of the two base portions 51A at two positions in an area on the X1 side of the base portions 51A.

The housing 52 is made of an electric insulating material such as resin. As illustrated in FIGS. 13A and 13B, the housing 52 has an approximately rectangular parallelepiped outer shape with the terminal arrangement direction as the longitudinal direction. An end portion on the X2 side, or more specifically a portion extending toward X2 beyond the edge of the circuit board P1, of the housing 52 is slightly smaller in the terminal arrangement direction (the Z-axis direction) than the other portion of the housing 52. The end portion is formed with receiving groove portions 52A that each receive the power contact portion 241D of the respective power male terminal 241, at positions each between the power female terminals 51 in the terminal arrangement direction. The receiving groove portions 52A penetrate in the front-and-back direction (the Y-axis direction), and are open toward X2. Each of the receiving groove portions 52A is configured in such a manner as to be capable of receiving the respective power contact portion 241D in any direction of from the front (the Y1 side) and from the back (the Y2 side).

The accommodating portions 52B that each accommodate and hold the respective power female terminal 51 are formed in the housing 52 in such a manner as to be arranged in the terminal arrangement direction. Each of the accommodating portions 52B includes a hole portion extending substantially throughout the length of the housing 52 in the coupling direction (the X-axis direction). As illustrated in FIG. 13B, the accommodating portions 52B are open on the X1 side in the coupling direction (refer to FIG. 13B), but are blocked on the X2 side in the coupling direction (FIG. 13A). Moreover, as illustrated in FIG. 13A, a portion on the X2 side of each of the accommodating portions 52B, or more specifically a portion corresponding to a power male terminal accommodating portion of each of the receiving groove portions 52A in the coupling direction, is formed with an opening portion 52B-1 that is open on each side in the terminal arrangement direction. As illustrated in FIG. 13B, a front wall portion (a wall portion facing the circuit board P1), which forms the accommodating portions 52B, of the housing 52 is formed with slits 52B-2 extending in the coupling direction (the X-axis direction) in an area on the X1 side.

The power female terminals 51 are press-fitted into the accommodating portions 52B from the X1 side in the coupling direction, and held at the held portions 51B. The power contact arm portions 51E are exposed from the opening portions 52B-1 toward the receiving groove portions 52A in a state where the power female terminals 51 are attached to the accommodating portions 52B. At this point in time, the power contact portions 51E-1 of the power contact arm portions 51E protrude into the receiving groove portions 52A. Moreover, the power connection portions 51C enter the above slits 52B-2 of the housing 52 from the X1 side, and extend out forward from a front surface of the housing 52.

An end portion on the X2 side and on each end side in the terminal arrangement direction of the housing 52 includes a female-side latch portion 52C as a second latch portion. The female-side latch portions 52C are formed as ridge portions that protrude outward in the terminal arrangement direction (the Z-axis direction) and extend in the front-and-back direction (the Y-axis direction), at positions on the X2 side of the above end portions. The female-side latch portions 52C extend uniformly in straight lines throughout their length in the front-and-back direction. The female-side latch portions 52C are configured in such a manner as to be capable of being latched in the coupling direction to male-side latch portions provided to the power male connector 204 (refer to FIGS. 3A and 3B) being the mating connector. As illustrated in FIGS. 13A and 13B, recessed portions 52E are formed on the X1 side of the above end portions relative to the female-side latching portions 52C. The recessed portions 52E are open outward in the terminal arrangement direction, and penetrate and extend in the up-and-down direction.

A fitting holding portion 52D that holds the fitting 53 is formed on an end surface in the terminal arrangement direction of each end portion on the X1 side of the housing 52. Each of the fitting holding portions 52D is configured in such a manner to have a groove portion extending in the front-and-back direction, in which the respective fitting 53 is press-fitted and held.

The fittings 53 have the same shape as the fittings 43 already described. As with the fittings 43, each of the fittings 53 includes a held portion 53A and two fixed portions 53B. Detailed descriptions of portions of each of the fittings 53 are omitted here. The held portion 53A of each of the fittings 53 is press-fitted into the respective fitting holding portion 52D from the back, and therefore, each side edge portion (each edge portion extending in the front-and-back direction) of the held portion 53A is held by the respective fitting holding portion 52D. Moreover, each of the fixed portions 53B is inserted through its corresponding hole-like portion formed in the circuit board P1 and fixed and connected by soldering to the corresponding portion.

Next, the configuration of the case 6 is described with reference to FIGS. 2A to 2C. In FIGS. 2A to 2C, the configuration is provided, taking the terminal arrangement direction (the Z-axis direction) as the up-and-down direction. Here, in the description of the case 6, the Z1 side in the terminal arrangement direction is assumed to be “upward,” and the Z2 side is assumed to be “downward.” The case 6 is made of synthetic resin such as resin and, as illustrated in FIGS. 2A and 2B, has a box shape having an approximately rectangular parallelepiped outer shape with the terminal arrangement direction (the up-and-down direction in FIGS. 2A and 2B) as the longitudinal direction.

Next, the configuration of the case 6 is described with reference to FIGS. 2A, 2B, and 2C. The case 6 accommodates and holds the connector mounted body 1 in a portion on the front side (the Y1 side). Each side surface of the case 6 in the coupling direction (the X-axis direction) is formed with opening portions in positions corresponding to the connectors 2 to 4. A mating portion (a portion to be mated and connected to a mating connector) of each of the connectors 2 to 4 is placed, exposed from the respective opening portion. In other words, the signal contact portions 21C-1, the power contact arm portions 22C, the female-side abutting portions 24D, and the female-side latch portions 241 of the control female connector 2 are exposed from the opening portion located in a lower portion (a portion on the Z2 side) of the side surface on the X1 side of the case 6. The power contact portions 41D and the male-side latch portions 42B of the power male connector 4 are exposed from the opening portion located in an upper portion (a portion on the Z1 side) of the side surface on the X1 side of the case 6. The signal contact portions 31B, the power contact portions 32B, the male-side latch portions 33D, and the male-side abutting portions 33E of the control male connector 3 are exposed from the opening portion located in a lower portion (a portion on the Z2 side) of the side surface on the X2 side of the case 6. The power contact arm portions 51E and the female side latch portions 52C of the power female connector 5 are exposed from the opening portion located in an upper portion (a portion on the Z1 side) of the side surface on the X2 side of the case 6.

As illustrated in FIG. 2A, a lower engagement recessed portion 61 is formed at a position corresponding in the up-and-down direction to the control female connector 2 in the lower portion (the portion on the Z2 side) of the side surface on the X1 side of the case 6, in such a manner as to extend in the front-and-back direction (the Y-axis direction). Moreover, an upper engagement recessed portion 62 is formed at a position corresponding in the up-and-down direction to the power male connector 4 in the upper portion of the above side surface in such a manner as to extend in the front-and-back direction. As illustrated in FIG. 2C, the lower engagement recessed portion 61 and the upper engagement recessed portion 62 can be engaged with a lower engagement protruding portion 164 and an upper engagement protruding portion 165, which are provided on a side surface on the X2 side of the case 106 (refer to FIG. 1A) of the module II. The engagement of these portions allows the cases 6 and 106 to be coupled.

As illustrated in FIG. 2A, each end portion of the lower engagement recessed portion 61 in the up-and-down direction is formed with a first lower guide portion 61A that guides the module II relatively in the front-and-back direction. Each of the first lower guide portions 61A extends uniformly throughout the length of the case 6 in the front-and-back direction (the Y-axis direction) except for the area of the respective female-side latch portion 241 of the control female connector 2. Each of the first lower guide portions 61A has an approximately L-shaped hook shape in cross section along a plane perpendicular to the front-and-back direction. The first lower guide portions 61A are provided at the same position as the female-side latch portions 24I as viewed in the front-and-back direction. Therefore, each of the first lower guide portions 61A is combined with the respective female-side latch portion 24I to form one guide portion extending throughout the total length of the case 6 in the front-and-back direction. Moreover, as illustrated in FIG. 2C, the first lower guide portions 61A are configured in such a manner as to be capable of being latched in the coupling direction to second lower guide portions 164A of the case 106 of the module II.

As illustrated in FIG. 2A, each end portion of the upper engagement recessed portion 62 in the up-and-down direction is formed with a first upper guide portion 62A that guides the module II relatively in the front-and-back direction. Each of the first upper guide portions 62A extends uniformly throughout the length of the case 6 in the front-and-back direction except for the area of the respective male-side latch portion 42B of the power male connector 4. Each of the first upper guide portions 62A has an approximately L-shaped hook shape in cross section along a plane perpendicular to the front-and-back direction. The first upper guide portions 62A are provided at the same position as the male-side latch portions 42B as viewed in the front-and-back direction. Therefore, each of the first upper guide portions 62A is combined with the respective male-side latch portion 42B to form one guide portion extending throughout the total length of the case 6 in the front-and-back direction. Moreover, as illustrated in FIG. 2C, the first upper guide portions 62A are configured in such a manner as to be capable of being latched in the coupling direction to second upper guide portions 165B of the case 106 of the module II.

Each end portion in the up-and-down direction of the side surface on the X1 side of the case 6 is formed with a first end guide portion 63 that guides the module II relatively in the front-and-back direction. The first end guide portions 63 extend uniformly throughout the length of the case 6 in the front-and-back direction. Each of the first end guide portions 63 has an approximately L-shaped hook shape in cross section along a plane perpendicular to the front-and-back direction. As illustrated in FIG. 2C, the first end guide portions 63 are configured in such a manner as to be capable of being latched in the coupling direction to second end guide portions 166 of the case 106 of the module II.

As illustrated in FIG. 2B, a lower engagement protruding portion 64 is formed at a position corresponding in the up-and-down direction to the control male connector 3 in the lower portion of the side surface on the X2 side of the case 6. Moreover, an upper engagement protruding portion 65 is formed at a position corresponding in the up-and-down direction to the power female connector 5 in the upper portion of the above side surface. The lower engagement protruding portion 64 and the upper engagement protruding portion 65 can be engaged with a lower engagement recessed portion 261 and an upper engagement recessed portion 262, which are provided on a side surface on the X1 side of the case 206 (refer to FIG. 1A) of the module III. The engagement of these portions allows the cases 6 and 206 to be coupled.

Each end portion of the lower engagement protruding portion 64 in the up-and-down direction is formed with a second lower guide portion 64A that guides the module III relatively in the front-and-back direction. The second lower guide portions 64A are formed as ridge portions that protrude upward and downward, respectively, and extend in the front-and-back direction. Each of the second lower guide portions 64A extends uniformly in a straight line throughout the length of the case 6 in the front-and-back direction except for the area of the respective male-side latch portion 33D of the control male connector 3. The second lower guide portions 64A are provided at the same position as the male-side latch portions 33D as viewed in the front-and-back direction. Therefore, each of the second lower guide portions 64A is combined with the respective male-side latch portion 33D to form one guide portion extending throughout the total length of the case 6 in the front-and-back direction. The second lower guide portions 64A enter, in the front-and-back direction, groove portions formed in first lower guide portions 261A (refer to FIG. 1A) of the case 206 of the module III to guide the first lower guide portions 261A relatively in the front-and-back direction. Moreover, the second lower guide portions 64A are configured in such a manner as to be capable of being latched in the coupling direction to the first lower guide portions 261A.

As illustrated in FIG. 2B, the upper engagement protruding portion 65 is formed with guide groove portions 65A each at a position corresponding to the respective receiving groove portion 52A of the power female connector 5 in the up-and-down direction (the terminal arrangement direction). Each of the guide groove portions 65A allows the entry of the respective power contact portion 241D (refer to FIG. 1A) of the power male connector 204 provided to the module III. The guide groove portions 65A extend throughout the length of an area backward (on the Y2 side) of the power female connector 5. Each of the guide groove portions 65A is combined with the respective receiving groove portion 52A to form one guide groove portion.

Each end portion of the upper engagement protruding portion 65 in the up-and-down direction is formed with a second upper guide portion 65B that guides the module III relatively in the front-and-back direction. The second upper guide portions 65B are formed as ridge portions that protrude upward and downward, respectively, and extend in the front-and-back direction. Each of the second upper guide portions 65B extends uniformly in a straight line throughout the length of the case 6 in the front-and-back direction except for the area of the respective female-side latch portion 52C of the control female connector 5. The second upper guide portions 65B are provided at the same position as the female-side latch portions 52C as viewed in the front-and-back direction.

Therefore, each of the second upper guide portions 65B is combined with the respective female-side latch portion 52C to form one guide portion extending throughout the total length of the case 6 in the front-and-back direction. The second upper guide portions 65B enter, in the front-and-back direction, groove portions formed in first upper guide portions 262A (refer to FIG. 1A) of the case 206 of the module III to guide the first upper guide portions 262A relatively in the front-and-back direction. Moreover, the second upper guide portions 65B are configured in such a manner as to be capable of being latched in the coupling direction to the first upper guide portions 262A.

Each end portion in the up-and-down direction of the side surface on the X2 side of the case 6 is formed with a second end guide portion 66 that guides the case 206 of the module III relatively in the front-and-back direction. The second end guide portions 66 extend uniformly throughout the length of the case 6 in the front-and-back direction. Each of the second end guide portions 66 has an approximately L-shaped hook shape in cross section along a plane perpendicular to the front-and-back direction. The second end guide portions 66 are formed as ridge portions that protrude upward and downward, respectively, and extend in the front-and-back direction. The second end guide portions 66 enter, in the front-and-back direction, groove portions formed in first end guide portions 263 (refer to FIG. 1A) of the case 206 of the module III to guide the first end guide portions 263 relatively in the front-and-back direction. Moreover, the second end guide portions 66 are configured in such a manner as to be capable of being latched in the coupling direction to the first end guide portions 263.

Next, the operation of connecting the modules is described. In the embodiment, a description is given of the operation of inserting and connecting the module I between the module II and the module III, which have already been attached to the rail (not illustrated). The module I is inserted and connected in this manner, so that the modules I, II, and III are coupled together to form one module coupled body. Firstly, the module I is placed backward (on the Y2 side) of the modules II and III at a corresponding position between the modules II and III in the coupling direction (the X-axis direction) as illustrated in FIG. 1A. Next, the module I is moved forward (in the Y1 direction), and inserted between the modules II and III.

On the side surface on the X1 side of the module I, when the module I starts being inserted, the lower engagement protruding portion 164 and the upper engagement protruding portion 165 (refer to FIG. 2C) of the module II enter, from the front, the lower engagement recessed portion 61 and the upper engagement recessed portion 62 (refer to FIGS. 2A and 2C) of the module I. At this point in time, the first lower guide portions 61A of the lower engagement recessed portion 61 are guided forward by the second lower guide portions 164A of the lower engagement protruding portion 164. Furthermore, the first upper guide portions 62A of the upper engagement recessed portion 62 are guided forward by the second upper guide portions 165B of the upper engagement protruding portion 165. Moreover, the second end guide portions 166 of the module II enter the first end guide portions 63 of the module I from the front. As a result, the first end guide portions 63 are guided forward by the second end guide portions 166.

On the side surface on the X2 side of the module I, the lower engagement protruding portion 64 and the upper engagement protruding portion 65 (refer to FIG. 2B) of the module I enter, from the back, the lower engagement recessed portion 261 and the upper engagement recessed portion 262 (refer to FIG. 1A) of the module III. At this point in time, the second lower guide portions 64A of the lower engagement protruding portion 64 are guided forward by the first lower guide portions 261A of the lower engagement recessed portion 261. Furthermore, the second upper guide portions 65B of the upper engagement protruding portion 65 are guided forward by the first upper guide portions 262A of the upper engagement recessed portion 262.

On the side surface on the X1 side of the module I, when the insertion of the module I proceeds, the power contact portions 41D of the power male connector 4 enter, from the back, guide groove portions 165A (refer to FIG. 2C) of the upper engagement protruding portion 165 of the module II. The power contact portions 41D are guided forward by the guide groove portions 165A.

When the insertion of the module I proceeds further, the module I is attached to the rail (not illustrated), and at the same time, the connectors provided to the module I are mated and connected to their respective mating connectors provided to the modules II and III. Consequently, the connection operation of the module I is completed. As a result, as illustrated in FIG. 1B, the modules I to III are coupled together, arranged in a line in the coupling direction to finish the module coupled body.

In the module coupled body, the control female connector 2 and the power male connector 4 of the module I are mated and connected to the control male connector 103 and the power female connector 105 (second mating connectors) of the module II, respectively (refer to FIGS. 3A and 3B). Moreover, the control male connector 3 and the power female connector 5 of the module I are mated and connected to the control female connector 202 and the power male connector 204 (first mating connectors) of the module III, respectively (refer to FIGS. 3A and 3B).

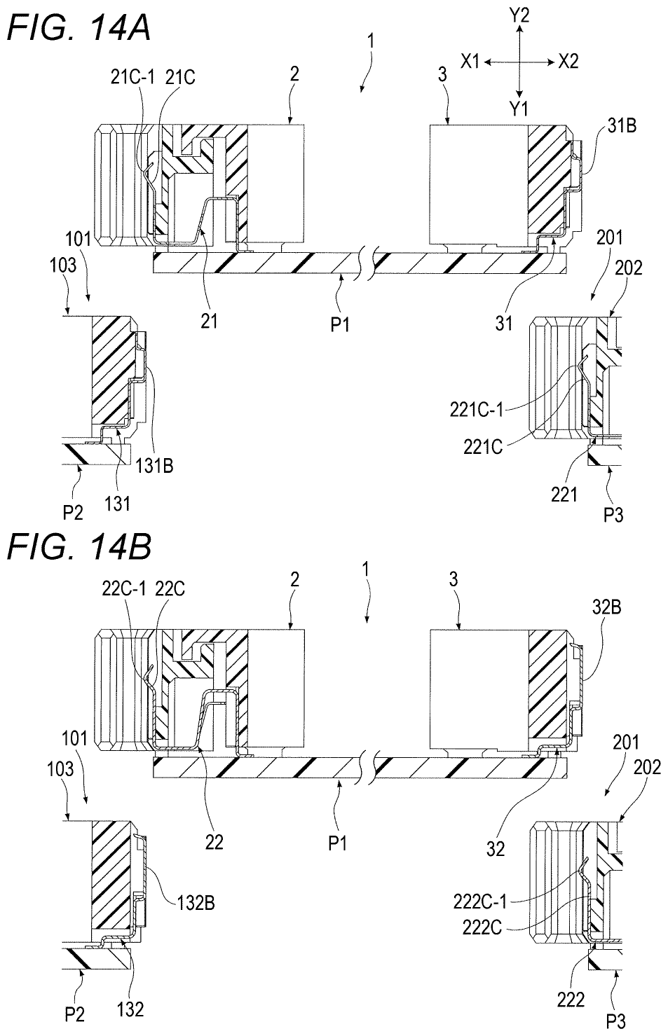

The operation of mating and connecting the connectors, which is performed in the course of inserting and connecting the module I already described, is described below with reference to FIGS. 14 to 18. As already described, the control female connector 2 of the module I is mated and connected to the control male connector 103 of the module II. Moreover, the control male connector 3 of the module I is mated and connected to the control female connector 202 of the module III. FIGS. 14A and 14B are cross-sectional views of the connector mounted bodies 1, 101, and 201 immediately before the start of the mating and connection operation, taken along a plane (the XY-plane) perpendicular to the terminal arrangement direction (the Z-axis direction). FIG. 14A illustrates a cross section of the connector mounted bodies 1, 101, and 201 at a position of the signal terminals of the control connector pair. FIG. 14B illustrates a cross section of the connector mounted bodies 1, 101, and 201 at a position of the power terminals of the control connector pair. The illustration of a middle portion of the circuit board P1 in the coupling direction (the X-axis direction) is omitted in FIGS. 14A and 14B.

As illustrated in FIGS. 14A and 14B, the connector mounted body 1 is placed backward (upward in FIGS. 14A and 14B) of the connector mounted bodies 101 and 201 immediately before the start of the mating and connection operation. The connector mounted body 1 then moves forward (downward in FIGS. 14A and 14B) to start the operation of mating and connecting the connectors.

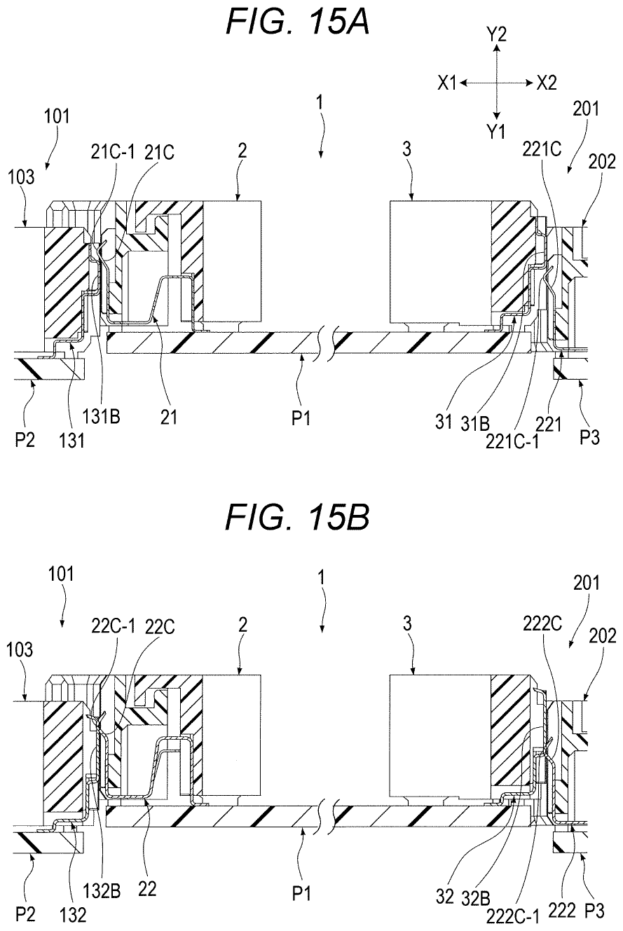

FIGS. 15A and 15B are cross-sectional views of the connector mounted bodies 1, 101, and 201 in the middle of the mating and connection operation, taken along the plane perpendicular to the terminal arrangement direction. FIG. 15A illustrates a cross section of the connector mounted bodies 1, 101, and 201 at the position of the signal terminals of the control connector pair. FIG. 15B illustrates a cross section of the connector mounted bodies 1, 101, and 201 at the position of the power terminals of the control connector pair. When the connector mounted body 1 starts moving forward, firstly the power contact portion 22C-1 of the power female terminal 22 of the control female connector 2 of the connector mounted body 1 comes into contact with a back end portion (an upper end portions in FIG. 15B) of a power contact portion 132B of a power male terminal 132 of the control male connector 103 of the connector mounted body 101 in a state where the power contact arm portion 22C is elastically deformed in the X2 direction as illustrated in FIG. 15B. Note that FIG. 15B illustrates the power contact arm portion 22C in an elastically undeformed state, but actually the power contact arm portion 22C is elastically deformed in the X2 direction.

At this point in time, as illustrated in FIG. 15A, the signal contact portion 21C-1 of the signal female terminal 21 of the control female connector 2 of the connector mounted body 1 is not in contact with a back end portion of a signal contact portion 131B of the signal male terminal 131 of the control male connector 103 of the connector mounted body 101. This is because the signal contact portion 21C-1 and the power contact portion 22C-1 of the control female connector 2 are provided at the same position in the front-and-back direction (the up-and-down direction in FIGS. 15A and 15B) while the back end portion of the power contact portion 132B of the control male connector 103 is located backward (upward in FIGS. 15A and 15B) of the signal contact portion 131B.

Moreover, as illustrated in FIG. 15B, a front end portion (a lower end portion in FIG. 15B) of the power contact portion 32B of the power male terminal 32 of the control male connector 3 of the connector mounted body 1 comes into contact with a power contact portion 222C-1 while a power contact arm portion 222C of a power female terminal 222 of the control female connector 202 of the connector mounted body 201 is elastically deformed in the X2 direction. At this point in time, as illustrated in FIG. 15A, the front end portion of the signal contact portion 31B of the signal male terminal 31 of the control male connector 3 of the connector mounted body 1 is not in contact with the power contact portion 222C-1 of the signal female terminal 221 of the control female connector 202 of the connector mounted body 201. This is because the signal contact portion 221C-1 and the power contact portion 222C-1 of the control female connector 202 are provided at the same position in the front-and-back direction (the up-and-down direction in FIGS. 15A and 15B) while the front end portion of the power contact portion 32B of the control male connector 3 is located forward (downward in FIGS. 15A and 15B) of the signal contact portion 31B. Note that FIG. 15B illustrates the power contact arm portion 222C in an elastically undeformed state, but actually the power contact arm portion 222C is elastically deformed in the X2 direction.

Depending on the specifications of electric connectors provided with both of signal terminals and power terminals, contact between the power terminals may be required prior to contact between the signal terminals in the middle of the operation of mating the electric connectors. In the embodiment, in terms of the male terminals 31 and 131 of the control male connectors 3 and 103, the front ends of the power contact portions 32B and 132B extending in the front-and-back direction are located forward of the signal contact portions 31B and 131B, and the back ends thereof are located backward of the signal contact portions 31B and 131B. Moreover, in terms of a plurality of the female terminals 221, 222, 21, and 22 provided to the control female connectors 202 and 2 being the mating connectors of the control male connectors 3 and 103, their contact portions 221C-1, 222C-1, 21C-1, and 22C-1 are formed at the same position in the front-and-back direction. Therefore, in the middle of the operation of mating the connectors, the power contact portions 32B and 132B come into contact with the power contact portions 222C-1 and 22C-1 before the signal contact portions 31B and 131B come into contact with the signal contact portions 221C-1 and 21C-1. In this manner, the embodiment can excellently meet the requirements of the above specifications.

When the connector mounted body 1 is located at the position of FIGS. 15A and 15B, the power male terminal 41 of the power male connector 4 of the connector mounted body 1 is not yet in contact with the power female terminal 151 of the power female connector 105 of the connector mounted body 101. Moreover, the power female terminal 51 of the power female connector 5 of the connector mounted body 1 is not yet in contact with the power male terminal 241 of the power male connector 204 of the connector mounted body 201.

The connector mounted body 1 is moved further forward from the position illustrated in FIGS. 15A and 15B, and placed at a position illustrated in FIGS. 16A and 16B, that is, a position where the connector mounted body 1 is at the same depth as the connector mounted bodies 101 and 201 in the front-and-back direction to complete the operation of mating and connecting the connectors. As illustrated in FIG. 16B, in a state where the mating and connection is complete, the power contact arm portion 22C of the power female terminal 22 of the control female connector 2 of the connector mounted body 1 deforms elastically in the X2 direction in the coupling direction, and the power contact portion 22C-1 is in contact with the power contact portion 132B of the power male terminal 132 of the control male connector 103 of the connector mounted body 101. At this point in time, as illustrated in FIG. 16A, the signal contact arm portion 21C of the signal female terminal 21 of the control female connector 2 of the connector mounted body 1 also deforms elastically in the X2 direction in the coupling direction, and the signal contact portion 21C-1 is in contact with the signal contact portion 131B of the signal male terminal 131 of the control male connector 103 of the connector mounted body 101. Note that FIGS. 16A and 16B illustrate the signal contact arm portion 21C and the power contact arm portion 22C in an elastically undeformed state, but actually the signal contact arm portion 21C and the power contact arm portion 22C are elastically deformed in the X2 direction.

Moreover, as illustrated in FIG. 16B, the power contact portion 32B of the power male terminal 32 of the control male connector 3 of the connector mounted body 1 elastically deforms the power contact arm portion 222C of the power female terminal 222 of the control female connector 202 of the connector mounted body 201 in the X2 direction in the coupling direction, and is in contact with the power contact portion 222C-1. At this point in time, as illustrated in FIG. 16A, the signal contact portion 31B of the signal male terminal 31 of the control male connector 3 of the connector mounted body 1 elastically deforms a signal contact arm portion 221C of the signal female terminal 221 of the control female connector 202 of the connector mounted body 201 in the X2 direction in the coupling direction, and is in contact with the signal contact portion 221C-1. Note that FIGS. 16A and 16B illustrate the signal contact arm portion 221C and the power contact arm portion 222C in an elastically undeformed state, but actually the signal contact arm portion 221C and the power contact arm portion 222C are elastically deformed in the X2 direction.

In this manner, each of a pair of the signal contact portion 21C-1 and the signal contact portion 131B, a pair of the power contact portion 22C-1 and the power contact portion 132B, a pair of the signal contact portion 31B and the signal contact portion 221C-1, and a pair of the power contact portion 32B and the power contact portion 222C-1 comes into contact with each other with the coupling direction (the X-axis direction) as a contact direction (a direction in which a contact pressure is generated). As a result, the control female connector 2 and the control male connector 103 are electrically connected together. Moreover, the control male connector 3 and the control female connector 202 are electrically connected together. Therefore, all the control connectors 2, 3, 103, and 202 can be brought into conduction.

Moreover, the power contact portion 41D of the power male terminal 41 of the power male connector 4 of the connector mounted body 1 enters, from the back, between two power contact portions 151E-1 of the power female terminal 151 of the power female connector 105 of the connector mounted body 101, and comes into contact with the power contact portions 151E-1. At this point in time, the two power contact portions 151E-1 compress the power contact portion 41D while deforming elastically in such a manner as to move apart from each other in the terminal arrangement direction. Moreover, two power contact portions 51E-1 of the power female terminal 51 of the power female connector 5 of the connector mounted body 1 receive the power contact portion 241D of the power male terminal 241 of the power male connector 204 of the connector mounted body 201 therebetween from the front, and come into contact with the power contact portion 241D. At this point in time, the two power contact portions 51E-1 compress the power contact portion 241D while deforming elastically in such a manner as to move apart from each other in the terminal arrangement direction.

In this manner, each of a pair of the power contact portion 41D and the power contact portion 151E-1 and a pair of the power contact portions 51E-1 and the power contact portion 241D comes into contact with each other with the terminal arrangement direction (the Z-axis direction) as the contact direction (the direction in which a contact pressure is generated). As a result, the power male connector 4 and the power female connector 105 are electrically connected together. Moreover, the power female connector 5 and the power male connector 204 are electrically connected together. Therefore, all the power connectors 4, 5, 105, and 204 can be brought into conduction.

In the connector mated and connected state, the female-side latch portions 24I of the moving housing 24 of the control female connector 2 are latched in the coupling direction to the male-side latch portions 133D of a housing 133 (a second mating housing) of the control male connector 103. Specifically, as illustrated in FIGS. 17A and 17B, the distal end portion of the female-side latch portion 24I is located in a recessed portion 133I (refer to FIG. 17B) of the housing 133, and the male-side latch portion 133D is located in the recessed portion 24J (refer to FIG. 17B) of the moving housing 24. At this point in time, as illustrated in FIG. 17B, slight gaps (play) are formed in the coupling direction between the distal end portion of the female-side latch portion 24I and an inner wall surface of the recessed portion 1331 and between the male-side latch portion 133D and an inner wall surface of the recessed portion 24J, respectively. Therefore, the moving housing 24 and the housing 133 mutually restrict movement in the coupling direction within the areas of the above gaps.

Moreover, as illustrated in FIG. 17B, the female-side abutting portion 24D of the moving housing 24 of the control female connector 2 abutting against the male-side abutting portion 133E of the housing 133 of the control male connector 103 in the terminal arrangement direction, and is latched thereto. A slight gap (play) is formed in the terminal arrangement direction between the female-side abutting portion 24D and the male-side abutting portion 133E. Therefore, the moving housing 24 and the housing 133 mutually restrict movement in the terminal arrangement direction within the area of the above gap. Note that, as illustrated in FIG. 17B, the above gap is smaller than the gap formed in the terminal arrangement direction between the distal end portion of the female-side latch portion 241 and the inner wall surface of the recessed portion 1331 and the gap formed in the terminal arrangement direction between the male-side latch portion 133D and the inner wall surface of the recessed portion 24J. Therefore, in the terminal arrangement direction, the distal end portion of the female-side latch portion 24I does not abut against the inner wall surface of the recessed portion 133I, and the male-side latch portion 133D does not abut against the inner wall surface of the recessed portion 24J, either.

Moreover, also in terms of the housing 33 of the control male connector 3 and a moving housing 224 (a first mating housing) of the control female connector 202, the male-side latch portions 33D are latched in the coupling direction to the female-side latch portions of the control female connector 202, and the male-side abutting portions 33E abut against and latched in the terminal arrangement direction to female-side abutting portions 224D, as in the above description of the control female connector 2 and the control male connector 103.

In the connector mated and connected state, the male-side latch portions 42B of the housing 42 of the power male connector 4 are latched in the coupling direction to the female-side latch portions 152C of a housing 152 (a second mating housing) of the power female connector 105. Specifically, as illustrated in FIGS. 18A and 18B, the male-side latch portions 42B are located in recessed portions 152E (refer to FIG. 18B) of the housing 152, and distal end portions of the female-side latch portions 152C are located in the recessed portions 42D (refer to FIG. 18B) of the housing 42. At this point in time, as illustrated in FIG. 18B, slight gaps (play) are formed in the coupling direction between the male-side latch portion 42B and an inner wall surface of the recessed portion 152E and between the distal end portion of the female-side latch portion 152C and an inner wall surface of the recessed portion 42D, respectively. Therefore, the housing 42 and the housing 152 mutually restrict movement in the coupling direction within the areas of the above gaps.

Moreover, each of a pair of the male-side latch portion 42B and the inner wall surface of the recessed portion 152E and a pair of the distal end portion of the female-side latch portion 152C and the inner wall surface of the recessed portion 42D is configured in such a manner as to be capable of abutting against and being latched to each other in the terminal arrangement direction. In other words, the male-side latch portion 42B has also a role as a first abutting portion, and the female-side latch portion 152C has also a role as a second abutting portion. As illustrated in FIG. 18B, the slight gaps (play) are formed in the terminal arrangement direction between the male-side latch portion 42B and the inner wall surface of the recessed portion 152E and between the distal end portion of the female-side latch portion 152C and the inner wall surface of the recessed portion 42D, respectively. Therefore, the housing 42 and the housing 152 mutually restrict movement in the terminal arrangement direction within the areas of the above gaps.

Moreover, also in terms of the housing 52 of the power female connector 5 and a housing 242 (a first mating housing) of the power male connector 204, the female-side latch portions 52C are latched to male-side latch portions of the power male connector 204 in the coupling direction and in the terminal arrangement direction as in the above description of the power male connector 4 and the power female connector 105.

In this manner, in the embodiment, the housings of the connectors to be connected to one another mutually restrict movement in the coupling direction and in the terminal arrangement direction. Hence, the positional relationships of the connectors stay within predetermined allowable areas. As a result, it is possible to excellently secure a state in which the connectors are in stable electrical contact with one another.

In the embodiment, the control female connector 2 is configured as what is called a floating connector that is configured in such a manner that the moving housing 24 is movable relative to the fixed housing 23. Therefore, even if relative positions of a connector provided to the connector mounted body 1 and a mating connector of a mating connector mounted body corresponding to the connector are displaced from their proper positions, the moving housing 24 moves (floats) in a direction that absorbs the displacement; therefore, all terminals of the connector can excellently come into contact with terminals of the mating connector. Moreover, even if the relative positions of a control connector pair and a power connector pair of the connector mounted body 1 or a mating connector mounted body are displaced from their proper positions, the moving housing 24 moves (floats) in a direction that absorbs the displacement; therefore, all terminals of the connectors can excellently come into contact with terminals of the mating connectors.

In the embodiment, the upper engagement protruding portion 165 of the case 106 of the module II is formed with the guide groove portions 165A (refer to FIG. 2C). The guide groove portions 165A guide the power contact portions 41D of the power male terminals 41 of the module I. On the other hand, a surface, which is perpendicular to the coupling direction (the X-axis direction), of the lower engagement protruding portion 164 of the case 106 is a flat surface expanding over the entire lower engagement protruding portion 164. The lower engagement protruding portion 164 is not formed with groove portions such as the above guide groove portions 165A (refer to FIG. 2C). Therefore, not the lower engagement protruding portion 164 but the upper engagement protruding portion 165 serves as a reference for positioning in the terminal arrangement direction in the course of the operation of mating and connecting the modules I and II.

In the embodiment, the power female connector 105 provided corresponding to the upper engagement protruding portion 165 serving as the reference for positioning, or the power male connector 4 to be mated and connected to the power female connector 105, is not configured as a floating connector. The control female connector 2, that is, a connector to be mated and connected to the control male connector 103 for the lower engagement protruding portion 164 that does not serve as a reference for positioning is configured as a floating connector. In this manner, a floating connector having a floating moving housing is not provided on a side that serves as a reference for positioning to enable excellent positioning of the modules, and by extension of the connectors.

Moreover, if the power male connector 4 having the power contact portions 41D that are guided by the guide groove portions 165A is configured as a floating connector, when there is an error in the relative positions of the modules I and II in the terminal arrangement direction, the power contact portions 41D result in moving in the mating direction while being pressed against groove inner surfaces of the guide groove portions 165A along the terminal arrangement direction in the course of mating and connecting the modules I and II. As a result, excessive contact forces act on the power contact portions 41D and the groove inner surfaces of the guide groove portions 165A, and the power contact portions 41D and the groove inner surfaces of the guide groove portions 165A come into sliding contact with each other, which may cause damage to the power contact portions 41D and the groove inner surfaces of the guide groove portions 165A. In the embodiment, the control female connector 2 having the terminals that are not guided by guide groove portions is a floating connector. Hence, it is possible to excellently suppress occurrence of damage to terminals and a case such as described above.

Moreover, in the embodiment, the power contact portions 41D and the power female terminals 151 to be connected to the power contact portions 41D are formed in such a manner as to have a large cross-sectional area since a relatively large power supply current flows. Hence, the power contact portions 41D and the power female terminals 151 are resistant to elastic deformation. Therefore, if the power male connector 4 including the power contact portions 41D, or the power female connector 105 including the power female terminals 151, is a floating connector, it is difficult to secure a sufficient floating amount (floating amount) of a moving housing. In the embodiment, the control female connector 2 including the female terminals 21 and 22 that have a relatively small cross-sectional area and are susceptible to elastic deformation is configured as a floating connector. Hence, it facilitates securing a sufficiently large floating amount. Therefore, it is possible to excellently absorb an error between connectors. Note that a floating connector in a pair of the modules I and II is described here, but the same applies to a pair of the modules I and III.

In the embodiment, the female-side latch portions 241 of the control female connector 2, the male-side latch portions 33D of the control male connector 3, the male-side latch portions 42B of the power male connector 4, and the female-side latch portions 52C of the power female connector 5 of the module I, the male-side latch portions 133D of the control male connector 103, and the female-side latch portions 152C of the power female connector 105 of the module II, and the female-side latch portions of the control female connector 202 and the male-side latch portions of the power male connector 204 of the module III extend uniformly throughout their length in the front-and-back direction. In other words, latch portions corresponding to each other do not have portions that come into contact with each other from the front and from the back. Moreover, the receiving groove portions 52A of the power female connector 5 of the module I and receiving groove portions of the power female connector 105 of the module II penetrate in the front-and-back direction. In other words, these receiving groove portions are configured in such a manner as to be capable of receiving a power contact portion of a mating connector in any direction of from the front and front the back.

Moreover, in the embodiment, the first lower guide portions 61A, the first upper guide portions 62A, the first end guide portions 63, the second lower guide portions 64A, the second upper guide portions 65B, and the second end guide portions 66 of the case 6 of the module I, the second lower guide portions 164A, the second upper guide portions 165B, and the second end guide portions 166 of the case 106 of the module II, the first lower guide portions 261A, the first upper guide portions 262A, and the first end guide portions 263 of the case 206 of the module III extend uniformly throughout their length in the front-and-back direction. In other words, guide portions corresponding to each other do not have portions that come into contact with each other from the front and from the back. Moreover, the guide groove portions 65A of the case 6 of the module I and the guide groove portions 165A of the case 106 of the module II penetrate in the front-and-back direction. These guide groove portions are configured in such a manner as to be capable of receiving a power contact portion of a mating connector in any direction of from the front and from the back.

Therefore, in the embodiment, as already described, the module I can be inserted and connected between the modules II and III, maintaining a state in which the modules II and III are attached to the rail, while interference of the module I with the modules II and III is suppressed. Moreover, the module I, which has been inserted and connected in this manner, is pulled backward, so that the module I can be removed from between the modules II and III while the interference of the module I with the modules II and III is suppressed.

In other words, in the embodiment, when the need arises to replace only the module I provided at the middle position in the coupling direction in the module coupled body in which the modules I, II, and III are coupled together, it is possible to easily remove only the module I while suppressing the interference with the modules II and III. Moreover, it is possible to easily insert a new replaced module I between the modules II and III while suppressing interference with the modules II and III. Therefore, there is no need to attach and detach the other modules II and III upon the replacement work of the module I at the middle position. Hence, the replacement work of the module I is easy, and working efficiency improves.

In the embodiment, the example in which the module coupled body is formed by coupling the three modules I, II, and III is described. In terms of this, the number of modules coupled together is not limited to three, and is simply required to be more than one. Moreover, in the embodiment, the example in which two connector pairs are provided to each module is described. In terms of this, the number of connector pairs provided to each module is not limited to two, and may be one, or three or more.

In the embodiment, a connector pair includes a male connector and a female connector. In terms of this, it is not essential that a connector pair include such a male and a female connector. As a modification, a connector pair may include, for example, hermaphrodite connectors having the same shape.

In the embodiment, only one connector of a control connector pair is configured as a floating connector. Instead of this, both connectors of the control connector pair may be configured as floating connectors. Moreover, in the embodiment, floating connectors are adopted only for one of two connector pairs. As a modification, floating connectors may be adopted for the other connector pair, or both connector pairs.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electric connector mounted body comprising:
a circuit board; and
an electric connector pair mounted on a mount surface of the circuit board, wherein
the electric connector mounted body is configured to be capable of being coupled with a plurality of other electric connector mounted bodies, taking one predetermined direction as a coupling direction,
the electric connector mounted body is configured to be capable of mating and connecting to a mating electric connector mounted body adjacent to each side of the electric connector mounted body in the coupling direction, taking, as a mating direction, a forward facing direction in a front-and-back direction perpendicular to the coupling direction,
each of electric connectors included in the electric connector pair includes a plurality of terminals arranged taking, as a terminal arrangement direction, a direction perpendicular to both of the front-and-back direction and the coupling direction, and a housing that holds the plurality of terminals,
the electric connector pair includes, as the electric connectors, a first connector mounted on one side of the circuit board in the coupling direction, and a second connector mounted on the other side of the circuit board in the coupling direction,
the first connector is configured to be capable of mating and connecting to a second mating connector provided to the mating electric connector mounted body,
the second connector is configured to be capable of mating and connecting to a first mating connector provided to the other mating electric connector mounted body,
the first connector has no portions that come into contact with the second mating connector from a front and from a back, and
the second connector has no portions that come into contact with the first mating connector from the front and from the back.

2. The electric connector mounted body according to claim 1, wherein
the first connector includes a first terminal as the terminal, and a first housing as the housing that holds the first terminal,
the second connector includes a second terminal as the terminal, and a second housing as the housing that holds the second terminal,
the first housing includes a first latch portion that is capable of being latched to a second mating housing of the second mating connector in the coupling direction, and
the second housing includes a second latch portion that is capable of being latched to a first mating housing of the first mating connector in the coupling direction.

3. The electric connector mounted body according to claim 1, wherein
the first connector includes a first terminal as the terminal, and a first housing as the housing that holds the first terminal,
the second connector includes a second terminal as the terminal, and a second housing as the housing that holds the second terminal,
the first housing includes a first abutting portion that is capable of abutting against a second mating housing of the second mating connector in the terminal arrangement direction, and
the second housing includes a second abutting portion that is capable of abutting against a first mating housing of the first mating connector in the terminal arrangement direction.

4. The electric connector mounted body according to claim 1, further comprising a plurality of types of the electric connector pairs, wherein
each of the terminals of at least one type of specific electric connector pair has a shape obtained by bending a metal plate member in a thickness direction thereof, and includes a contact portion that comes into contact with a mating terminal provided to the mating electric connector mounted body, and
each of the contact portions is configured to be capable of coming into contact with the mating terminal, taking a plate surface intersecting the coupling direction as a contact surface.

5. The electric connector mounted body according to claim 4, wherein
the plurality of terminals provided to one electric connector of the specific electric connector pair includes a power terminal and a signal terminal,
the power terminal includes a power contact portion as the contact portion capable of coming into contact with the mating terminal corresponding to the power terminal,
the signal terminal includes a signal contact portion as the contact portion capable of coming into contact with the mating terminal corresponding to the signal terminal, and
the power contact portion is formed in such a manner as to extend in the front-and-back direction, and a front end thereof is located forward of the signal contact portion, and a back end thereof is located backward of the signal contact portion.

6. The electric connector mounted body according to claim 4, wherein
the contact portion of each of the terminals of at least one electric connector of the specific electric connector pair is formed at a position closer to one end side of the terminal in a longitudinal direction thereof in such a manner as to extend in the front-and-back direction,
each of the terminals includes a free end portion extending up to a free end on the one end side continuously with a back end of the contact portion, and
a portion, which is coupled with the back end of the contact portion, of the free end portion bends with a component directed toward an opposite side to the contact surface in the coupling direction.

7. The electric connector mounted body according to claim 1, further comprising a plurality of types of the electric connector pairs, wherein
the housing of one electric connector of at least one type of specific electric connector pair include a fixed housing and a moving housing, and the terminals of the electric connector are provided in such a manner as to bridge the fixed housing and the moving housing,
the fixed housing is fixed to the circuit board via the terminals,
each of the terminals includes an elastically deformable elastic portion between a fixed-side held portion held by the fixed housing and a moving-side held portion held by the moving housing, and
the moving housing is configured to be movable relative to the fixed housing due to elastic deformation of the elastic portions.

8. The electric connector mounted body according to claim 7, wherein the fixed housing includes a fixed-side restriction portion capable of being latched to the moving housing in the coupling direction.

9. The electric connector mounted body according to claim 7, wherein the moving housing includes a moving-side restriction portion protruding toward the mount surface of the circuit board and being capable of coming into contact with the mount surface.

10. The electric connector mounted body according to claim 7, wherein
the terminals include a power terminal and a signal terminal,
the power terminal is formed to be larger in the terminal arrangement direction than the signal terminal, and
the elastic portion of the power terminal is formed to be longer than the elastic portion of the signal terminal.

11. A first connector provided to the electric connector mounted body according to claim 1.

12. A second connector provided to the electric connector mounted body according to claim 1.

13. A module comprising:
the electric connector mounted body according to claim 1; and
a case configured to accommodate the electric connector mounted body.

14. A module coupled body comprising a plurality of the modules according to claim 13, which are coupled together.
